(19) United States
(12) Patent Application Publication
(10) Pub. No.: US 2024/0428255 A1
(43) Pub. Date: Dec. 26, 2024

(54) DISTRIBUTED LEDGER SYSTEM AND CONTROL METHOD FOR DISTRIBUTED LEDGER SYSTEM

(71) Applicant: Hitachi, Ltd., Tokyo (JP)

(72) Inventors: Satoshi ITO, Tokyo (JP); Tatsuya SATO, Tokyo (JP)

(21) Appl. No.: 18/611,790

(22) Filed: Mar. 21, 2024

(30) Foreign Application Priority Data
Jun. 21, 2023 (JP) 2023-101428

(51) Int. Cl. G06Q 20/40; G06Q 20/38

(52) U.S. Cl. CPC G06Q 20/407; G06Q 20/38215

(57) ABSTRACT

In a distributed ledger system that provides a consortium-type distributed ledger network, an upper limit number of management authorities to be delegated to an agent in the entire distributed ledger network is stored, and the current total number of delegations of management authority to the agent in the entire distributed ledger network is managed in a distributed ledger. A distributed ledger node, upon receiving a transaction requesting the delegation of new management authority, executes a first smart contract. The first smart contract determines whether the total number of delegations will exceed the upper limit number of delegations by delegating new management authority, and where the total number of delegations exceeds the upper limit number of delegations, determines to reject the request, and where the total number of delegations is less than the upper limit number of delegations, delegates new management authority and updates authority delegation information in the distributed ledger.

### CROSS-REFERENCE TO RELATED APPLICATION

The present application claims priority from Japanese Application No. 2023-101428, filed on Jun. 21, 2023, the content of which is hereby incorporated by reference into this application.

### TECHNICAL FIELD

The present invention relates to a distributed ledger system and a method for controlling a distributed ledger system.

### BACKGROUND ART

In recent years, technology (hereinafter referred to as “distributed ledger technology”) has been developed that allows transactions that were previously conducted through centralized institutions such as financial institutions and governments to be performed directly between users by recording them on a distributed ledger (hereinafter also referred to as a “blockchain”) managed by a P2P (Peer to Peer) network (hereinafter referred to as a “distributed ledger network”) configured using individual user information processing devices, and application to various fields is progressing.

Regarding distributed ledger technology, Patent Literature 1, for example, describes a certificate distribution system configured for the purpose of improving the availability of management of electronic certificates used to prevent impersonation of others when recording information regarding transactions in a distributed ledger.

In addition, Non-Patent Literature 1, for example, describes technology in which transactions that have been carried out via trustworthy centralized institutions such as financial institutions and governments can now be carried out directly between users using virtual currency using a distributed ledger.

Moreover, Non-Patent Literature 2 and Non-Patent Literature 3, for example, describe a Smart Contract (also called a “Chaincode”), which is a technology that updates a distributed ledger by executing predefined processing triggered by an event such as a transaction.

### CITATION LIST

### Patent Literature

Patent Literature 1: JP 2018-117287 A

### Non-Patent Literature

Non-Patent Literature 1: “A Peer-to-Peer Electronic Cash System”, [online], [Retrieved May 26, 2023], Internet bitcoin.org/bitcoin.pdf
Non-Patent Literature 2: “Ethereum White Paper”, [online], [searched on May 26, 2023], Internet ethereum.org/en/whitepaper
Non-Patent Literature 3: “Hyperledger Fabric”, [online], [searched on May 26, 2023], Internet hyperledger-fabric.readthedocs.io/en/latest SUMMARY

### Technical Problem

The above-described distributed ledger technology has the following characteristics.
(1) In transactions between participants in a distributed ledger network, transactions are finalized through consensus and approval by arbitrary or specific participants, rather than by a centralized institution.
(2) By managing a plurality of transactions as blocks, stringing the blocks together and recording the blocks in a distributed ledger and recording hash values in consecutive blocks, it is virtually impossible to tamper with the recorded contents.
(3) All participants share the same ledger data, and thus all participants can confirm the details of transactions.

In this way, distributed ledger technology eliminates the need for management by a centralized institution and makes it possible to share information and conduct transactions among multiple entities.

As usage forms of distributed ledger technology, there are public types that do not assume the existence of a specific administrator as described in Non-Patent Literature 1, private types that assume the existence of a single administrator, and consortium types that assume the existence of multiple administrators as described in Non-Patent Literature 3. Among these, the private type and consortium type are also called permission types because permission from the administrator is required to arrange operations in the distributed ledger network.

Of the above usage types, the consortium type is viewed as promising for cases in which multiple organizations (for example, a consortium in a specific industry or multiple companies involved in a supply chain) operate in concert, and is particularly viewed as promising for the enterprise field (i.e., for use in finance, industry, distribution, public services, IT infrastructure, social infrastructure, and the like). In the consortium type, for example, each node (hereinafter referred to as a “distributed ledger node”) of multiple organizations participating in a distributed ledger network (consortium) synchronizes and works together based on a consensus protocol, and executes transactions according to the predetermined contract details (smart contract).

In the consortium type, in order that only permitted organizations are able to participate in the distributed ledger network, a mechanism is required to identify, certify, and manage the identity and authority of organizations (hereinafter referred to as “participating organizations”) and users participating in the distributed ledger network, and such a mechanism is implemented using encryption technology such as electronic certificates. More specifically, for example, a Certificate Authority (CA) prepared for a distributed ledger network issues a public key certificate (also referred to as an “electronic certificate”, and hereinafter abbreviated as “certificate”) corresponding to a private key to identify each participating organization or user. In a distributed ledger network, a certificate issued by a certificate authority and a private key corresponding to a public key are used to authenticate participating organizations and members of participating organizations, sign transactions, control smart contract execution authority, and the like.

In the consortium type, in order to ensure decentralization by eliminating elements that depend on a single organization such as a centralized institution (hereinafter also referred to as a “single point of trust”), a distributed ledger network is constructed by bringing together distributed ledger nodes owned and managed by each organization. In addition, in the consortium type, and also in order to avoid there being a single point of trust for the certificate authority used, multiple certificate authorities are prepared to be in charge of each participating organization.

In the consortium type, each organization operates its own distributed ledger node using its own authority (private key). In addition, common settings for the consortium are operated by obtaining consent and approval from multiple organizations using each organization's authority (private key). Therefore, as a general rule, it is preferable for an organization to operate its own distributed ledger nodes. However, in reality, there may be cases where it is necessary to have an agent perform the operation of the distributed ledger node on behalf of an organization, such as in a case of reducing operational man-hours or when outsourcing complex operations to another organization. Note that the above-mentioned other organization is assumed to be a service provider that provides infrastructure of a distributed ledger network as a service, such as a provider that provides distributed ledger nodes in the cloud.

In a case where each organization participating in a distributed ledger network requests an agent to operate its own distributed ledger node, the security of authority management becomes an issue. For example, in a case where a specific single business operator acts as an agent to handle the operations of multiple organizations participating in a distributed ledger network, the business operator can obtain management authority (keys) for multiple organizations at the same time, and thereby it becomes possible to tamper with the distributed ledger and consortium settings.

The above-mentioned Patent Literature 1 describes that the functions of a certificate authority are implemented using a distributed ledger and a smart contract. However, the certificate distribution system described in Patent Literature 1 does not manage the authority of the distributed ledger nodes (consortium) as a whole.

The present invention was conceived in view of this background, and has as an object to provide a distributed ledger system and a method for controlling the distributed ledger system that is capable of reducing risks when delegating the operation of a distributed ledger network.

### Solution to the Problem

One aspect of the present invention for solving the above problems is a distributed ledger system including a plurality of distributed ledger nodes provided by each of a plurality of organizations, wherein the distributed ledger system provides a distributed ledger network configured by the plurality of distributed ledger nodes, the distributed ledger system executes a smart contract according to a transaction received from outside, the smart contract records information in a distributed ledger while building a consensus among the plurality of distributed ledger nodes, each of the plurality of organizations utilizes the distributed ledger network using management authority granted to each organization, the distributed ledger system stores an upper limit number of delegations that is an upper limit number of management authorities to be delegated to an agent that performs operations related to the distributed ledger network in an entire distributed ledger network, the distributed ledger system manages authority delegation information in the distributed ledger, the authority delegation information including information indicating a total number of delegations that is a current number of delegations of the management authority to the agent in the entire distributed ledger network, the distributed ledger node executes a first smart contract when the distributed ledger node receives the transaction requesting delegation of new management authority, and the first smart contract: Determines whether or not the total number of delegations exceeds the upper limit number of delegations by delegating the new management authority; in a case where the total number of delegations exceeds the upper limit number of delegations, determines to reject the request; and in a case where the total number of delegations is less than the upper limit number of delegations, performs a process of delegating the new management authority and updates the authority delegation information in the distributed ledger.

### Effect of the Invention

With the present invention, it is possible to reduce risks when delegating the operation of a distributed ledger network.

### BRIEF DESCRIPTION OF THE DRAWINGS

FIG. 1A is a diagram illustrating the flow when a participating organization delegates management authority to an agent.

FIG. 1B is a diagram illustrating the flow of returning management authority to a participating organization.

FIG. 1C is a diagram schematically illustrating a configuration of a distributed ledger system according to a first embodiment.

FIG. 2A is an example of a blockchain (BC).

FIG. 2B is an example of a blockchain (BC) (continued from FIG. 2A).

FIG. 2C is an example of a blockchain (BC) (continued from FIG. 2B).

FIG. 2D is an example of a blockchain (BC) (continued from FIG. 2C).

FIG. 3 is an example of state information.

FIG. 4 is an example of consortium information.

FIG. 5 is a diagram illustrating an authority delegation management SC, state information, and SC events.

FIG. 6 is an example of authority delegation information.

FIG. 7 is a flowchart illustrating an SC deployment/execution process.

FIG. 8 is a flowchart illustrating an authority delegation process.

FIG. 9 is a flowchart illustrating an authority return process.

FIG. 10A is a diagram illustrating the flow of delegation management authority to an agent (second embodiment).

FIG. 10B is a diagram illustrating the flow when returning management authority (second embodiment).

FIG. 10C is a diagram schematically illustrating a configuration of a distributed ledger system (second embodiment).

FIG. 11 is a diagram illustrating an authority delegation management SC, state information, and SC events (second embodiment).

FIG. 12A is an example of an agent menu (second embodiment).

FIG. 12B is an example of authority delegation information (second embodiment).

FIG. 13 is a flowchart illustrating an authority delegation consent process (second embodiment).

FIG. 14 is a diagram illustrating an authority delegation management SC, state information, and SC events (third embodiment).

FIG. 15 is a flowchart illustrating an authority delegation process (third embodiment).

FIG. 16 is an example of an information processing device used to achieve a distributed ledger system.

### DESCRIPTION OF EMBODIMENTS

Embodiments of the present invention are described below with reference to the drawings. Note that the following embodiments are merely examples for describing the present invention, and are omitted and simplified as appropriate for clarity of explanation. The present invention can also be implemented in various other forms. Unless otherwise specified, each component may be singular or plural.

In the following, examples of various types of information may be described using expressions such as “information” and “data”; however, various types of information may be expressed using data structures other than these (such as “table” and the like). In addition, in the following description, when describing identification information, expressions such as “identifier,” “ID,” and “identification information” may be used; however, these are interchangeable. Moreover, in the following description, the letter “S” added in front of a reference numeral means a processing step.

In the following description, the distributed ledger is also referred to as a “blockchain” or “BC”. Further, technology that uses a distributed ledger (blockchain (BC)) to enable direct transactions between users is hereinafter referred to as “distributed ledger technology.”

In addition, a Peer to Peer (P2P) network, which is constructed using multiple information processing devices (hereinafter referred to as “distributed ledger nodes”) that are communicably connected via a communication network, which is the basis for using distributed ledger technology, will hereinafter be referred to as a “distributed ledger network” or a “consortium.” Moreover, organizations such as companies and government offices that participate in a distributed ledger network (consortium) are referred to as “participating organizations.”

Furthermore, a smart contract provided by distributed ledger technology is also referred to as an “SC” below. In addition, a transaction issued for a smart contract (SC) is also referred to as a “TX”.

In the following, a distributed ledger system, which is an information processing system that provides a mechanism for using a distributed ledger network, will be explained. A distributed ledger system includes nodes of each organization (hereinafter referred to as “client nodes”), distributed ledger nodes of each organization (provided by each organization to configure the distributed ledger system (distributed ledger network)), and one or more certificate authority nodes (hereinafter referred to as “Certificate Authority (CA) nodes”) that are responsible for issuing a public key certificate (also referred to as an “electronic certificate”, hereinafter referred to as a “certificate”) of each organization. These nodes (client nodes, distributed ledger nodes, CA nodes) are communicably connected by being connected via a communication network.

In addition, in the following description, participating organizations or members of participating organizations are identified by a private keys and certificates in public key cryptography (hereinafter, the combination of a private key and a certificate is also referred to as an “identity”). Identities are issued by a CA node that is responsible for issuing certificates for each organization. The certificate includes information indicating the role of the participating organization or the role of the member of the participating organization. In the distributed ledger network, the availability of the distributed ledger network is determined using the above information. Hereinafter, the authority to operate the distributed ledger network and distributed ledger nodes will be referred to as “management authority.”

A smart contract (SC) (hereinafter referred to as an “authority delegation management SC” (first smart contract)) for managing the total number of delegations of management authority for the entire distributed ledger network (consortium) in the distributed ledger, and for processes related to the delegation and return of management authority, is deployed for each distributed ledger node of a distributed ledger node group that makes up a distributed ledger system.

When the distributed ledger node receives an execution transaction (TX) of an authority delegation management SC, the distributed ledger node executes the authority delegation management SC. The authority delegation management SC determines whether or not to delegate management authority when a participating organization requests an agent to operate the distributed ledger network, and implements processing related to issuing management authority performed via a CA node. By passing the issued management authority to an agent, the agent will be able to perform operation of the distributed ledger network on behalf of the participating organizations. The above operation includes, for example, work for maintaining and operating the distributed ledger network (distributed ledger nodes), and work related to the work that participating organizations perform using the distributed ledger network; however, as long as the work requires management authority, the contents of the operation to be requested to the agent are not necessarily limited.

Note that the executing entity of the smart contract (SC) deployed at the distributed ledger nodes is each distributed ledger node that makes up the distributed ledger system; however, for the sake of simplicity, the description below may focus on one distributed ledger node group (with a single distributed ledger node as the subject).

### First Embodiment

As embodiments of the present invention, a case in which the agent is a participating organization of a distributed ledger network (consortium) and a case in which the agent is not a participating organization will be assumed. In the first embodiment, a mechanism will be described for a case in which the agent is not a participating organization.

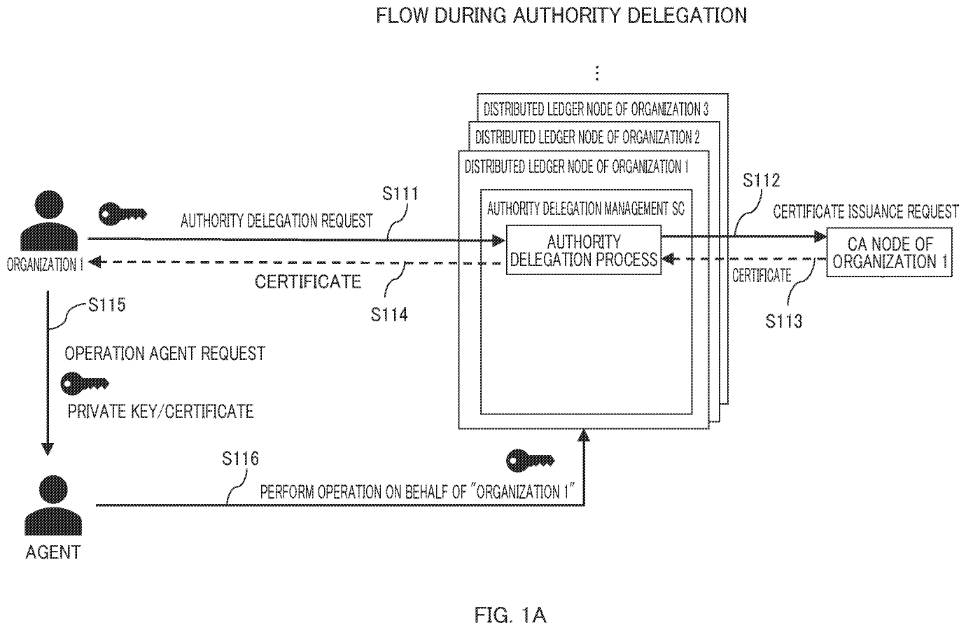

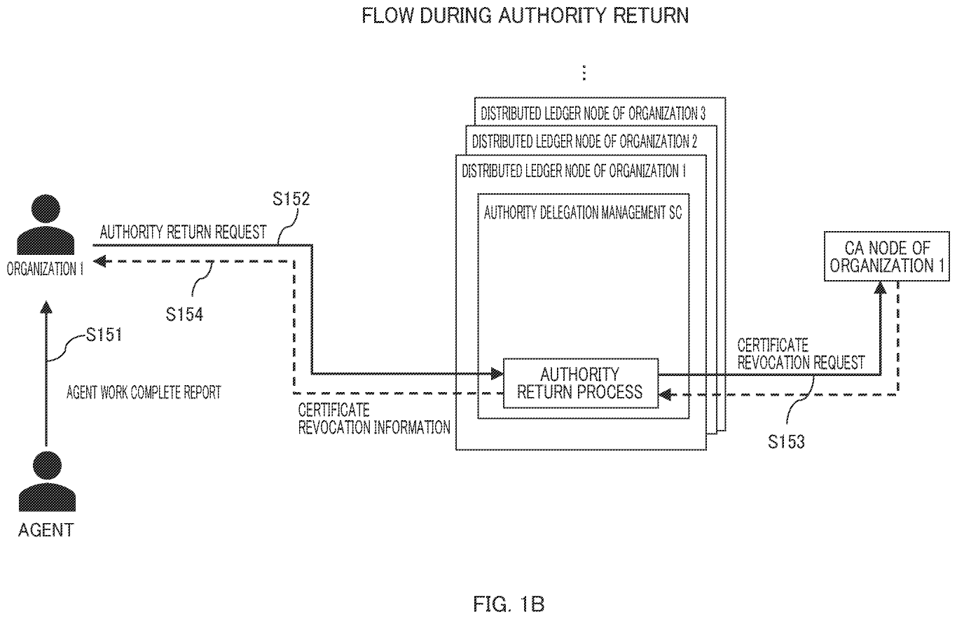

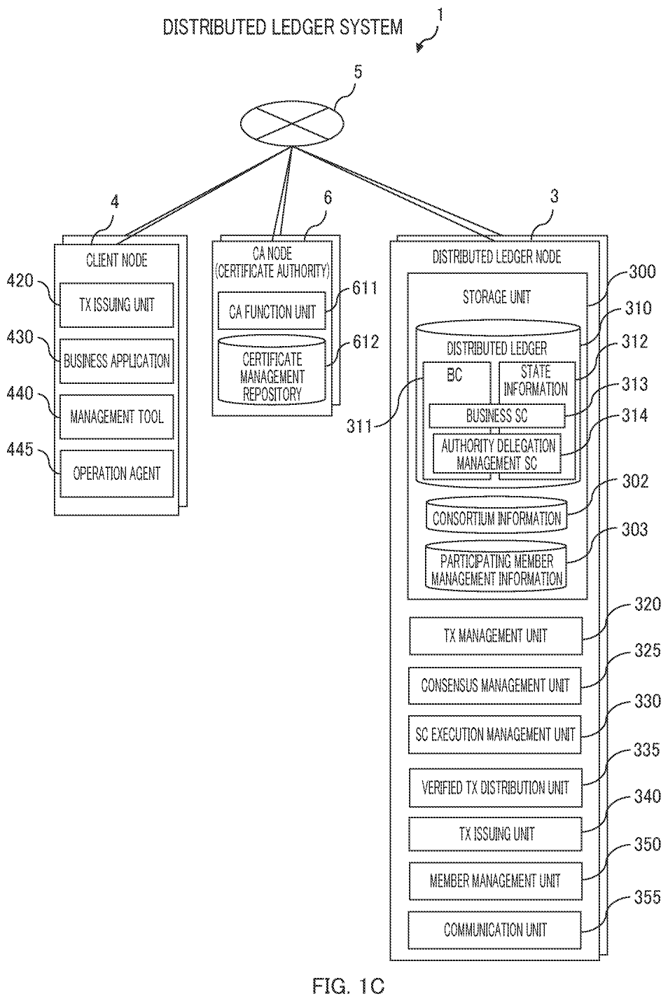

FIG. 1A is a diagram illustrating the flow when a participating organization delegates management authority to an agent.

As illustrated in the FIG. 1A, first, a participating organization (hereinafter referred to as “Organization 1”) that wishes to request an agent to operate business on its behalf transmits a request for delegating management authority (hereinafter referred to as an “authority delegation request”) to a distributed ledger node (distributed ledger node group) (S111). Note that the authority delegation request is made by transmitting a transaction (TX) from the client node of “Organization 1” to the distributed ledger node requesting execution of an authority delegation management SC regarding the delegation of management authority.

In the authority delegation management SC process, when a distributed ledger node (distributed ledger node group) receives an authority delegation request, the distributed ledger node acquires the current total number of delegations of management authority for the entire distributed ledger network, and determines whether or not the total number of delegations will exceed a preset upper limit (hereinafter referred to as “upper limit number of delegations”) by newly delegating management authority. Note that the upper limit number of delegations is determined, for example, based on the risk of falsification of information (information managed by a distributed ledger network, or the like) due to multiple delegations of management authority.

In a case where the distributed ledger node allows the delegation of management authority (in a case where the total number of delegations does not exceed the upper limit number of delegations even if management authority is newly delegated), the distributed ledger node transmits a request to issue a certificate (hereinafter referred to as a “certificate issuance request”) to the CA node in charge of “organization 1” (S112). The authority delegation management SC receives the certificate issued by the CA node, and transmits the received certificate to “Organization 1” (S113, S114).

The “Organization 1” receives the certificate and then hands over the management authority (private key, certificate) to the agent (online or offline) (S115). The agent uses the handed over management authority to perform the operation related to the distributed ledger network of “Organization 1” on behalf of the organization (S116).

FIG. 1B is a diagram illustrating the flow when the management authority delegated to the agent in the flow of FIG. 1A is returned to the delegating organization (“Organization 1”).

First, the agent reports (online or offline) to the organization (“organization 1”) that the agent work has been completed (S151).

Upon receiving the above report, “Organization 1” transmits a request to return the management authority delegated to the agent (hereinafter referred to as “authority return request”) to the distributed ledger node (S152). Note that the authority return request is made by transmitting a transaction (TX) from the client node of “Organization 1” to the distributed ledger node requesting execution of the authority delegation management SC regarding the return of the management authority.

In the authority delegation management SC process, when the distributed ledger node (distributed ledger node group) receives the authority return request, the distributed ledger node transmits a certificate revocation request to the CA node in charge of “Organization 1” (S153) and information indicating that the certificate has been revoked (hereinafter referred to as “certificate revocation information”) to the client node, which is the node of “Organization 1” (S154). As a result, the management authority delegated to the agent will be revoked.

Note that, as the authority delegation request transmitted by “Organization 1” in S111 of FIG. 1A, for example, a certificate signing request (hereinafter referred to as “CSR”) is used. More specifically, the participating organization that wishes to request operation by an agent generates a public key cryptographic key pair (private key and public key (certificate)) to delegate to the agent, and generates a CSR using the generated key pair. Then, the participating organization attaches the generated CSR to the authority delegation request and transmits it to the distributed ledger node, and the distributed ledger node uses the CSR attached to the received authority delegation request when transmitting a certificate issuance request to the CA node. By adopting such a flow, transmission and reception of the private key does not occur in a series of processes by the authority delegation management SC, and theft of the private key can be prevented.

In addition, to manage the roles of participating organizations for each identity, for example, information on the organization unit (OU) in the certificate is used, and in a distributed ledger network, the above information is used to identify authority and perform control. Note that the OU field of the certificate issued by the CA node includes information that can determine “management authority”, “administrator reference”, “node authority”, “node reference authority”, and “client node authority” as role identifiers.

FIG. 1C is a diagram schematically illustrating configuration of the distributed ledger system 1 according to the first embodiment. As illustrated in the FIG. 1C, the distributed ledger system 1 includes one or more distributed ledger nodes 3, one or more client nodes 4, and one or more CA nodes 6.

The distributed ledger node 3, the client node 4, and the CA node 6 are all configured using information processing devices (computers). These are connected to each other via a communication network 5 so as to be able to communicate with each other bidirectionally. The communication network 5 is a wireless or wired communication infrastructure configured using network equipment, and is, for example, the Internet, a Local Area Network (LAN), a Wide Area Network (WAN), various public communication networks, dedicated lines, and the like.

Note that, in this embodiment, it is assumed that there is at least one or more distributed ledger node 3, client node 4, and CA node 6 in each participating organization. However, the configuration of the distributed ledger system 1 may be any other configuration as long as decentralization can be ensured (eliminating a single point of trust). For example, regarding the client node 4, the smart contract (SC) may be shared by multiple users by switching the authentication information attached to the transaction (TX) for each user. In addition, participating organizations that do not approve transactions (TX) do not necessarily have to have a distributed ledger node 3.

The distributed ledger system 1 provides a consortium-type distributed ledger network (consortium) composed of a plurality of distributed ledger nodes 3. Each participating organization using the distributed ledger network has one or more distributed ledger nodes 3 and one or more client nodes 4. Note that since the distributed ledger system 1 is a consortium-type distributed ledger network, in principle each organization operates its own distributed ledger node 3. It should also be noted that the distributed ledger nodes 3 and client nodes 4 owned by participating organizations only need to be in a state where they can be used directly by the participating organizations (in a state where they can be operated and managed), and they do not necessarily have to be owned by the participating organizations.

As illustrated in FIG. 1C, the distributed ledger node 3 includes functions of a storage unit 300, a transaction management unit (hereinafter referred to as “TX management unit 320”), a consensus management unit 325, and a smart contract execution management unit (hereinafter referred to as “SC execution management unit 330”), a verified TX distribution unit 335, a transaction issuing unit (hereinafter referred to as “TX issuing unit 340”), a member management unit 350, and a communication unit 355.

Of the above functions, the storage unit 300 stores information (data) for the distributed ledger 310, consortium information 302, and participating member management information 303.

The distributed ledger 310 includes a blockchain (BC) (hereinafter referred to as “BC 311”), state information 312, a business SC 313, which is a smart contract (SC) for achieving processing related to an organization's business, and the above-mentioned authority delegation management SC 314. The authority delegation management SC 314 manages and controls the total number of delegations of management authority for the entire distributed ledger network (consortium).

In the BC 311, for example, a transaction (TX) history (reception history, execution history) is managed. In addition, in the state information 312, for example, information based on the history of transactions (TX) and information necessary for executing a smart contract (SC) (hereinafter referred to as “state information”) are managed. The state information 312 is managed, for example, in a table of a database managed by a DBMS (Data Base Management System) such as NOSQL. The state information 312 includes, for example, information based on the execution result of a transaction (TX) managed in Key-Value format.

The consortium information 302 includes information on the organizations that make up the distributed ledger network, information on various consensus conditions among the organizations, and the like. The consortium information 302 is shared between distributed ledger nodes 3 of each organization.

The participating member management information 303 includes information (identification information (identifier), authentication information, various attribute information, and the like) regarding members of the participating organization (including various nodes, administrators, users, and the like).

The TX management unit 320 receives transactions (TX) sent from other devices such as a client node 4. The TX management unit 320 also performs processing related to acquisition of transaction (TX) history (reception history, execution history) and execution results, presentation of transaction (TX) execution results (presentation via user interface, etc.), and the like. Moreover, when a transaction (TX) is received, the TX management unit 320 cooperates with the member management unit 350 to perform processing related to authentication and signature of the issuer (client node, member, and the like) of the transaction (TX).

The consensus management unit 325 performs processing related to consensus building with other distributed ledger nodes 3 as to whether a transaction (TX) received from a client node 4 or a distributed ledger node 3 may be accepted. When a consensus is established, the consensus management unit 325 cooperates with the SC execution management unit 330 to deploy a smart contract (SC), execute the deployed smart contract (SC), and record the history of the transaction (TX) and the execution result of the transaction (TX) in the distributed ledger 310.

The SC execution management unit 330 performs processing related to the deployment of a smart contract (SC) and the execution of a deployed smart contract (SC) in a case where a consensus is established with another distributed ledger node 3. Note that consensus building and execution of a smart contract (SC) do not necessarily need to be carried out by all distributed ledger nodes 3 that make up the distributed ledger network. Consensus building and execution of a smart contract (SC) may be performed between some of the distributed ledger nodes 3, and the result may be distributed to other distributed ledger nodes 3 via the communication network 5 in cooperation with the verified TX distribution unit 335 (the arrangement in that case depends on the consensus-building algorithm).

The verified TX distribution unit 335 distributes the results of the above consensus building and execution of the smart contract (SC) (transactions (TX), the history, execution results, and the like) via the communication network 5 to the distributed ledger nodes 3 that do not participate in the above consensus building or execution of the smart contract (SC).

The TX issuing unit 340 issues a transaction (TX) to the distributed ledger nodes 3.

The member management unit 350 performs processing related to registration of participating organizations and members. In addition, the member management unit 350 also performs authentication processing for participating organizations and members. The member management unit 350 performs, for example, authentication of participating organizations and members using key pairs, signing transactions (TX), and controlling execution authority of smart contracts (SC). Information on participating organizations and members is managed by the participating member management information 303. The above information is updated at any time in conjunction with the issuance or revocation of a certificate by the CA node 6.

The communication unit 355 performs processing related to communication with the client nodes 4 and other distributed ledger nodes 3 and communication with the CA node 6 via the communication network 5. For example, the communication unit 355 performs communication regarding consensus building among other distributed ledger nodes 3, distribution of approved transactions (TX) to other distributed ledger nodes 3, and the like.

The consortium information 302 includes information on participating organizations, consensus conditions for accepting transactions (TX) regarding the execution of smart contracts (SCs) (hereinafter referred to as “SC consensus conditions”), consensus conditions for accepting transactions (TX) for changing the settings of the distributed ledger network, and the like. The SC consensus conditions are recorded in the distributed ledger 310. The consortium information 302 is shared between distributed ledger nodes 3 of each organization.

As illustrated in FIG. 1C, the client node 4 has the following functions: a TX issuing unit 420, a business application 430, a management tool 440, and an operation agent 445.

The TX issuing unit 420 transmits various transactions (TX) to the distributed ledger nodes 3 in response to operational inputs from smart contract (SC) users and providers and instructions from the business application 430. Information (identification information, authentication information, identity, and the like) of an issuing source (transmission source) (organization, member, client node 4) of a transaction (TX) is attached to a transaction (TX).

The business application 430 is a function implemented by application software that performs or supports business performed by an organization. For example, when providing a function related to business, the business application 430 transmits (issues) a transaction (TX) related to the business SC 313 to the distributed ledger node 3 in cooperation with the TX issuing unit 420. The agent uses, for example, the business application 430 to perform the business of the participating organization on behalf of the participating organization.

When a participating organization requests an agent to act on its behalf, the management tool 440 transmits an authority delegation request to the distributed ledger node 3 (issues a transaction (TX) requesting execution of an authority delegation management SC 314 regarding delegation of management authority). When transmitting an authority delegation request to the distributed ledger node 3, the management tool 440 generates a key pair to be delegated to an agent, generates a CSR using the generated key pair, and includes it in the authority delegation request. In addition, when the participating organization requests the return of the management authority delegated to the agent, the management tool 440 transmits an authority return request to the distributed ledger node 3 (issues a transaction (TX) requesting execution of the authority delegation management SC 314 regarding return of management authority).

The operation agent 445 accesses the CA node 6 in response to an instruction from the distributed ledger node 3 and executes (for example, automatically executes) processing related to certificate issuance requests and revocation requests for management authority. When the operation agent 445 completes the processing according to the instructions from the authority delegation management SC 314, the operation agent 445 issues a transaction (TX) for reporting the processing result (transaction (TX) for causing the authority delegation management SC 314 to execute the processing for the above report), and reports the results of the above processing to the distributed ledger node 3.

Note that, as a general rule, it is assumed that only the operation agent 445 has the authority necessary to issue, or to request revocation of, a management authority certificate to the CA node 6, and that access is restricted so that members of the organization cannot directly make the above request to the CA node 6 via the client node 4. In addition, in this embodiment, the operation agent 445 is implemented by the client node 4; however, similar functions may be implemented by other nodes (such as information processing devices separately prepared for authority control) connected to the communication network 5. In addition, the operation agent 445 may be made to function as a resident program, for example.

As illustrated in FIG. 1C, the CA node 6 includes the functions of a CA function unit 611 and a certificate management repository 612. Upon receiving an identity issuance request, the CA function unit 611 issues an identity according to the received issuance request and records the information in the certificate management repository 612. In addition, upon receiving an identity revocation request, the CA node 6 performs an identity revocation process and records the information in the certificate management repository 612.

Moreover, the CA node 6 checks the current certificate issuance status and revocation status based on the information stored in the certificate management repository 612 (reference function). For example, the CA node 6 uses a CSR for a process for issuing an identity, and uses a certificate revocation list (CRL) for a process for revoking an identity. Furthermore, the CA node 6 uses a certificate organization unit (OU), for example, to manage roles within the organization for each identity. Note that the distributed ledger network uses, for example, OU information to identify and control management authority.

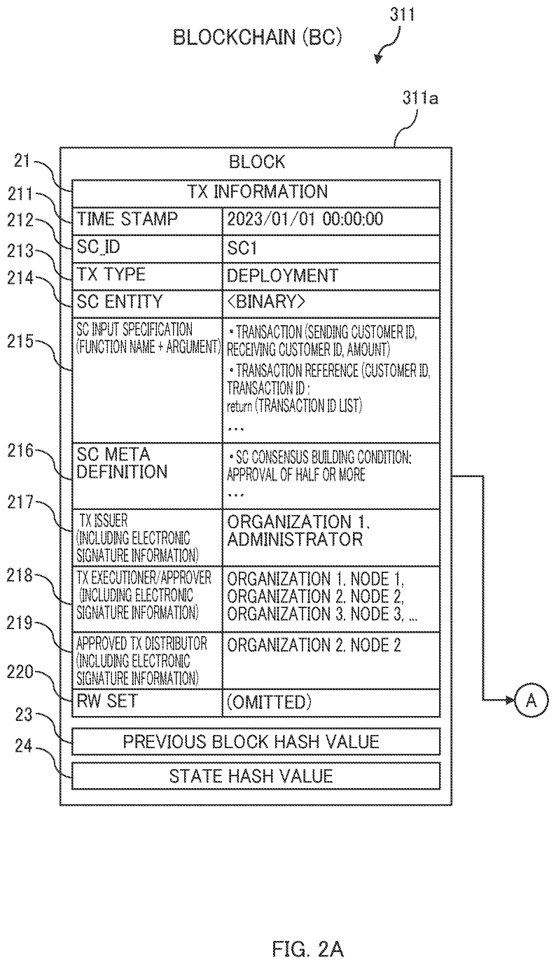

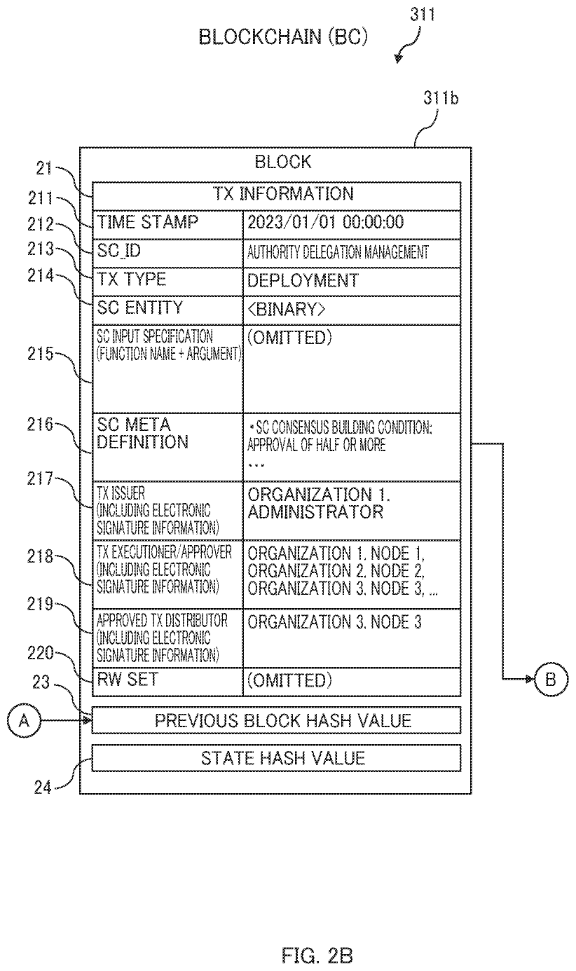

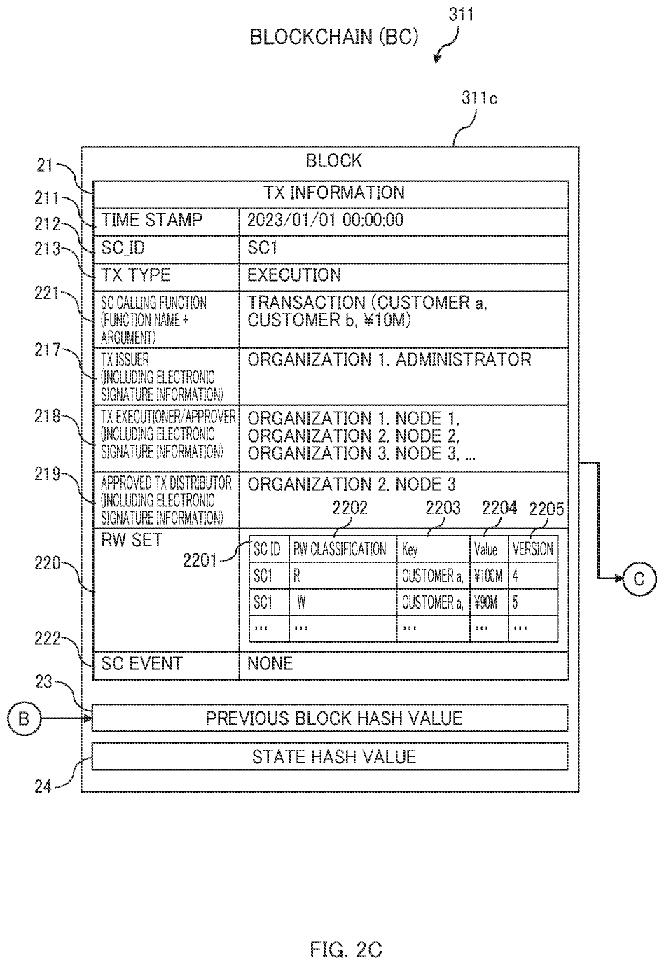

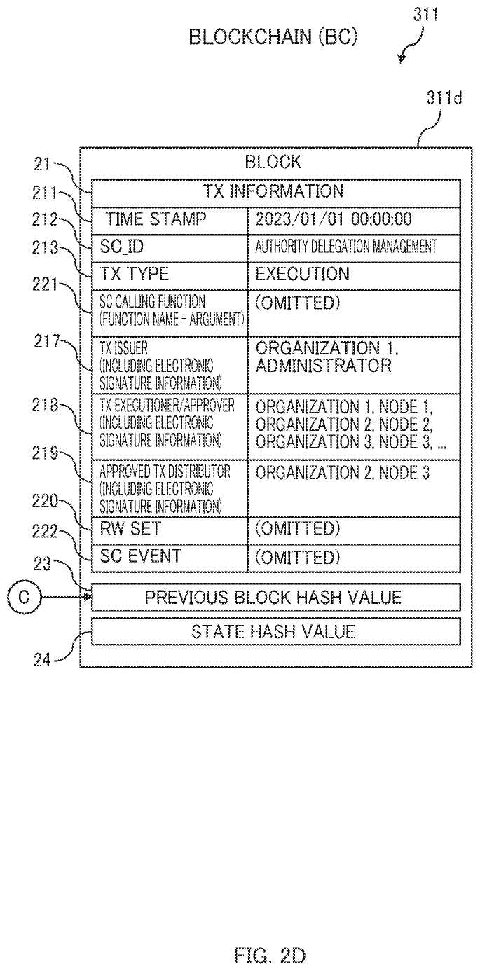

FIG. 2A to FIG. 2D are examples of a data structure of each block of the blockchain (BC) (BC311) of the distributed ledger 310 illustrated in FIG. 1C. In distributed ledger technology, multiple transactions (TX) are each managed as a block, and the blockchain (BC) (BC311) has a structure in which is the blocks are chained together so that each block has the hash value of the previous block. With the above structure, in a case where the value of the previous block changes even by one bit, the hash values of all subsequent blocks also change, making it difficult for malicious parties to tamper with the contents.

Note that, in this embodiment, although a case in which one transaction (TX) and one block correspond one-to-one is illustrated, a plurality of transactions (TX) may correspond to one block. Furthermore, in this example, smart contracts (SCs) are connected as a single blockchain (BC); however, other configurations may be used as long as each participating organization is able to access the smart contracts (SCs). In addition, in this example, a plurality of smart contracts (SC) are individually defined; however, they may be aggregated into a single smart contract (SC).

Each block 311a to 311d illustrated in FIGS. 2A to 2D includes information for TX information 21, a previous block hash value 23, and a state hash value 24 (a hash value generated from state information, described later).

The block 311a illustrated in FIG. 2A includes information on a transaction (TX) (hereinafter referred to as a “deployment TX”) for deploying the business SC 313. Note that the business SC 313 is, for example, a smart contract (SC) of a business related to a business contract in commercial transactions (transactions of virtual currency between organizations such as companies).

As illustrated in FIG. 2A, the TX information 21 of the block 311a includes a timestamp 211, SC_ID 212, TX type 213, SC entity 214, SC input specification 215, SC meta definition 216, TX issuer 217, TX execution/approver 218, approved TX distributor 219, and RW set 220.

Among these, the timestamp 211 stores the date and time (time stamp) when the transaction (TX) was issued.

The SC_ID 212 stores an identifier (hereinafter referred to as “SC_ID”) of a smart contract (SC) (the relevant business SC).

The TX type 213 stores information (“deploy” in this example) indicating the type of the transaction (TX) (“deploy”, “execution”, “reference”, and the like).

The SC entity 214 stores the entity (for example, executable binary data (execution code), and the like) of a smart contract (SC) (relevant business SC).

The SC input specification 215 stores information that allows the user to understand function names and arguments thereof included in the smart contract (SC). In the illustrated block 311a, a business SC 313 including at least the following functions (hereinafter referred to as “SC functions”) is defined.

Function name: transaction ( ), input arguments: sending customer ID, receiving customer ID, amount
Function name: Transaction reference ( ), Input arguments: Customer ID, Transaction ID, Return value: Transaction ID list

The SC meta definition 216 stores parameters determined according to input arguments specified when the smart contract (SC) is deployed. The above-mentioned parameters are, for example, the consensus conditions upon execution of the smart contract (SC) (for example, “accepting TX with approval from a majority of participating organizations, or the like”), and other various definition information.

The TX issuer 217 stores information on the issuer of the transaction (TX) (for example, the identifier (hereinafter referred to as “member ID”) of the issuer (client node 4, distributed ledger node 3, administrator, user, and the like), and information regarding electronic signatures (information used to verify an issuer and whether data has been tampered with), and the like. Note that the above electronic signatures are performed using each member's private key issued by the member management unit 350, and verified using the public key (certificate) of the private key.

Similar to the TX issuer 217, the TX execution/approver 218 stores information on participants (hereinafter referred to as “TX execution/approvers”) involved in consensus building and smart contract (SC) execution performed by the consensus management unit 325 and SC execution management unit 330 (information on participants involved in consensus building and SC execution processing by the consensus management unit 325 and SC execution management unit 330).

The approved TX distributor 219 stores information on participants (hereinafter referred to as “approved TX distributor”) involved in the distribution process by the verified TX distribution unit 335.

The RW set 220 stores information (hereinafter referred to as “RW set” (RW: Read-Write)) that is referenced or updated during the processing performed on the transaction (TX). Note that the RW set corresponds to the state information described above.

Block 311c illustrated in FIG. 2C is a transaction (hereinafter referred to as an “invoke TX”) for (executing) functioning (calling) the business SC deployed by the deployment TX of block 311a illustrated in FIG. 2A.

As illustrated in FIG. 2C, the TX information of the illustrated block 311c includes a timestamp 211, a SC_ID 212, a TX type 213, a calling function/input argument 221, a TX issuer 217, a TX execution/approver 218, and an approved TX distributor 219, a RW set 220, and a SC event 222. Note that of the above items, the timestamp 211, SC_ID 212, TX issuer 217, TX execution/approver 218, and approved TX distributor 219 are the same as those in block 311a of FIG. 2A, so an explanation of them will be omitted.

In a case where the process executed by the invoke TX includes updating the distributed ledger 310, “execution” is stored in the TX type 213, and in a case where the process executed by the invoke TX is a reference process that does not include the update process of the distributed ledger 310, “reference” is stored in the TX type 213. In the present example, “execution” is stored in the TX type 213.

A SC function called by a smart contract (SC) and an input argument given to the SC function are stored in the calling function/input argument 221. In this example, “transaction ( )” as the SC function and input arguments “customer a, customer b, ¥10M” are stored in the calling function/input argument 221.

Information (RW set) that is referenced or updated during the process performed on the transaction (TX) as described above is stored in the RW set 220. In this example, information that is referenced/updated when a smart contract (SC) is deployed or executed is stored in the RW set 220.

In the illustrated block 311c, a table having one or more records having the following items: SC_ID 2201, RW classification 2202, Key 2203, Value 2204, and version 2205 is stored in the RW set 220.

Among the above items, a smart contract (SC) identifier (SC_ID) is stored in the SC_ID 2201.

The SC_ID and information indicating whether it is a reference (Read) or an update (Write) (hereinafter referred to as “RW classification”) is stored in the RW classification 2202.

Information referenced or updated by the smart contract (SC) specified by the SC_ID is stored in the Key 2203 and the Value 2204.

Information indicating the version of the above information corresponding to the pair of the SC_ID and the Key is stored in the Version 2205. The version is incremented by one each time the information above is updated, for example.

In the example in FIG. 2C, the SC function “Register (Customer a, Customer b, ¥10M)” of the smart contract (SC) is executed, the Key “Customer a” is referenced to acquire the Value “¥100M” of the version number “4” (first line), and information indicating that the version number has been updated to “5” as a result of updating with the Value “¥90M” is managed as an RW set.

In this way, the execution result of the transaction (TX) is managed as a RW set (state information). Therefore, by referencing the RW set, it is possible to directly acquire the execution result of the transaction (TX) without executing the smart contract (SC). Therefore, for example, the execution results of the transaction (TX) can be efficiently shared among a plurality of distributed ledger nodes 3 including a distributed ledger node 3 that does not execute a smart contract (SC).

The SC event 222 illustrated in FIG. 2C stores information (hereinafter referred to as “event information”) regarding an event (hereinafter referred to as “SC event”) generated by the distributed ledger node 3 (smart contract (SC)). The TX management unit 320 of the distributed ledger node 3 generates event information at a timing such as when adding a transaction (TX) history to the BC 311 of the distributed ledger 310, and stores the generated event information in the SC event 222.

Client nodes 4 and distributed ledger nodes 3 participating in the distributed ledger system 1 can reference the event information stored in the SC event 222 of the BC 311 via the communication network 5 (that is, event information may be shared between each distributed ledger node 3 and between each distributed ledger node 3 and each client node 4 via the SC event 222). In addition, the distributed ledger node 3 and the client node 4 may execute various processes according to the event information.

The deployment TX block of the business SC 313 (block 311a illustrated in FIG. 2A) and the invoke TX block of the business SC 313 (block 311c illustrated in FIG. 2C) have been described above; however, the deployment TX block (block 311b illustrated in FIG. 2B) of the authority delegation management SC 314 and the invoke TX block (block 311d illustrated in FIG. 2D) of the authority delegation management SC 314 have a similar configuration. Note that in this way, the business SC 313 and the authority delegation management SC 314 have a common block, and the functions of the distributed ledger node 3 for processing both can be shared. Therefore, the mechanism of the present embodiment can be efficiently implemented.

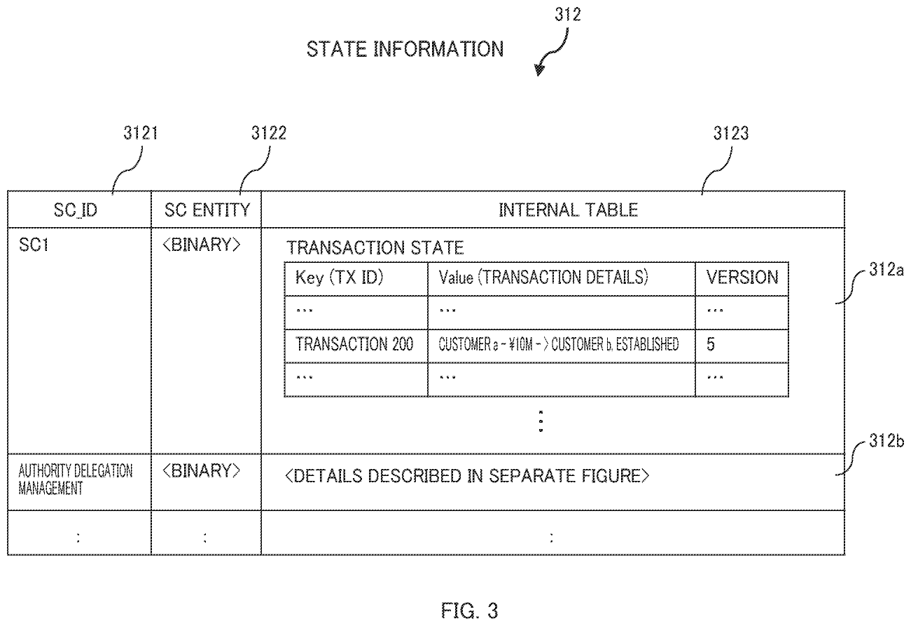

FIG. 3 is an example of the data structure of the state information 312 of the distributed ledger 310 illustrated in FIG. 1C. In an information management mechanism using a blockchain (BC), it is necessary to follow the blockchain (BC) in order to acquire the latest state of the information managed by the blockchain (BC) (for example, the latest balance of virtual currency when virtual currency is managed in the blockchain (BC)), which is inefficient. Therefore, in the present embodiment, a mechanism for managing the latest state of information managed by a blockchain (BC) as state information 312, which is obtained by reflecting all the contents of the RW set described above (for example, the mechanism described in non-patent literature 3) will be adopted. Note that, in the present embodiment, it is assumed that the SC execution management unit 330 acquires the entity of the smart contract (SC) using SC_ID as a key and executes the smart contract (SC), and it is assumed that the state information 312 is managed (a data storage area is prepared) for each smart contract (SC).

As illustrated in FIG. 3, the illustrated state information 312 includes one or more records having each item of a SC_ID 3121, a SC entity 3122, and an internal table 3123.

The SC_ID of the smart contract (SC) is stored in the SC_ID 3121.

A smart contract (SC) entity (for example, executable binary data (execution code), and the like) is stored in the SC entity 3122. Thus, the SC execution management unit 330 is able to acquire and execute the entity of the smart contract (SC) using the SC_ID as a key.

Information used when executing the smart contract (SC), such as execution results of the SC, is managed in the internal table 3123. The contents of the internal table 3123 are updated every time a transaction (TX) is executed. In this example, it is assumed that the internal table 3123 manages the latest values of the RW sets stored in the RW sets 220 illustrated in FIG. 2C and FIG. 2D.

In the example illustrated in FIG. 3, information is stored in the internal table 3123 in Key-Value format; however, Value may be stored in the internal table 3123 in other formats such as JSON (JavaScript Object Notation) (both “Java” and “Javascript” are registered trademarks) format. Accordingly, for example, information may be stored in the internal table 3123 as a table of an arbitrary data schema. In addition, by devising a key design, it is possible to virtually manage a plurality of pieces of information in the internal table 3123 with different schemas. In the present embodiment, the internal table 3123 related to the authority delegation management SC 314 is illustrated for a case of storing structured data in Value, and a description of Key-Value-Version and the like is omitted.

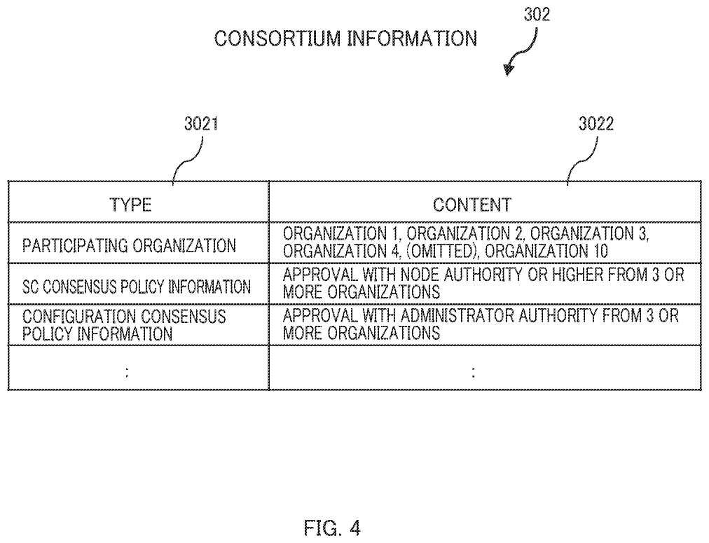

FIG. 4 is an example of the consortium information 302 illustrated in FIG. 1C. The consortium information 302 includes information on participating organizations, consensus conditions for accepting transactions (TX) regarding the execution of a smart contract (SC), and consensus conditions for accepting transactions (TX) for changing the settings of the distributed ledger network.

As illustrated in FIG. 4, the illustrated consortium information 302 is composed of a plurality of records having each item of type 3021 and content 3022. Information indicating the type of information is stored in the type 3021, and content corresponding to the type of information stored in the type 3021 is stored in the content 3022.

As illustrated in FIG. 4, in the illustrated consortium information 302, information corresponding to each type of “participating organization”, “SC Consensus Policy Information”, and “Configuration Consensus Policy Information” is stored in the content 3022.

Among these, a list of participating organizations in the distributed ledger network (consortium) (“Organization 1, Organization 2, Organization 3, Organization 4, (omitted), Organization 10”) is stored in the content 3022 of a record of which the Type 3021 is “participating organization”.

In addition, as the above-described SC consensus condition (consensus condition for accepting transactions (TX) regarding the execution of a smart contract (SC)), “Approval with node authority or higher from more than half of organizations” is stored in the content 3022 of which the type 3021 is “SC Consensus Policy Information”.

Moreover, as the consensus building condition necessary to change the settings of the distributed ledger system 1 (hereinafter referred to as “setting consensus condition”), “Approval with management authority from more than half of organizations” is stored in the content 3022 of which the type 3021 is “Configuration Consensus Policy Information”.

Note that this is only an example of the consensus condition illustrated in FIG. 4. For example, the consensus condition may specify the number of organizations, such as “Approval with management authority from three or more organizations”. In addition, the condition may be a complex combination of various conditions such as “Approval from a specific organization (for example, “Organization 1”) is required, and approval from one or more other optional organizations”.

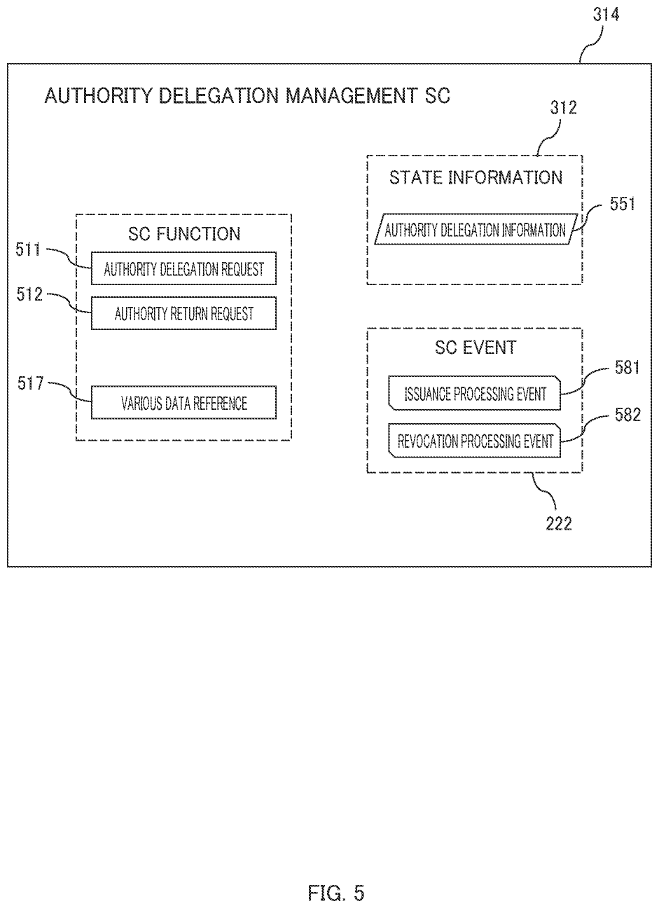

FIG. 5 is a diagram illustrating the authority delegation management SC 314, the state information 312 defined and operated by the authority delegation management SC 314, and the SC event 222 illustrated in FIG. 1C.

As illustrated in the FIG. 5, the authority delegation management SC 314 includes SC functions (authority delegation request 511, authority return request 512, and various data reference 517). Note that the SC function appropriately accesses (updates or references) the state information 312 and the SC event 222 of the BC 311 during execution.

Moreover, the illustrated state information 312 includes authority delegation information 551. The authority delegation information 551 includes information regarding the delegation of management authority for the consortium as a whole (hereinafter referred to as “authority delegation information”).

Furthermore, the illustrated SC event 222 includes an issuance processing event 581 and a revocation processing event 582.

Of these, the issuance processing event 581 is an SC event in which the distributed ledger node 3 instructs the operation agent 435 of the client node 4 to request the CA node 6 to issue a certificate.

In addition, the revocation processing event 582 is an SC event in which the distributed ledger node 3 instructs the operation agent 435 of the client node 4 to request the CA node 6 to revoke the certificate.

The SC function “authority delegation request 511” of the authority delegation management SC 314 is a function that performs processing related to a request for issuance of management authority to be delegated to an agent.

The SC function “authority return request 512” is a function that performs processing related to a return request (certificate revocation request) for management authority that has been delegated to an agent.

The SC function “various data reference 517” is a function (for example, a query function) that accesses information sources such as the distributed ledger 310, the consortium information 302, and the participating member management information 303 to acquire or refer to various data.

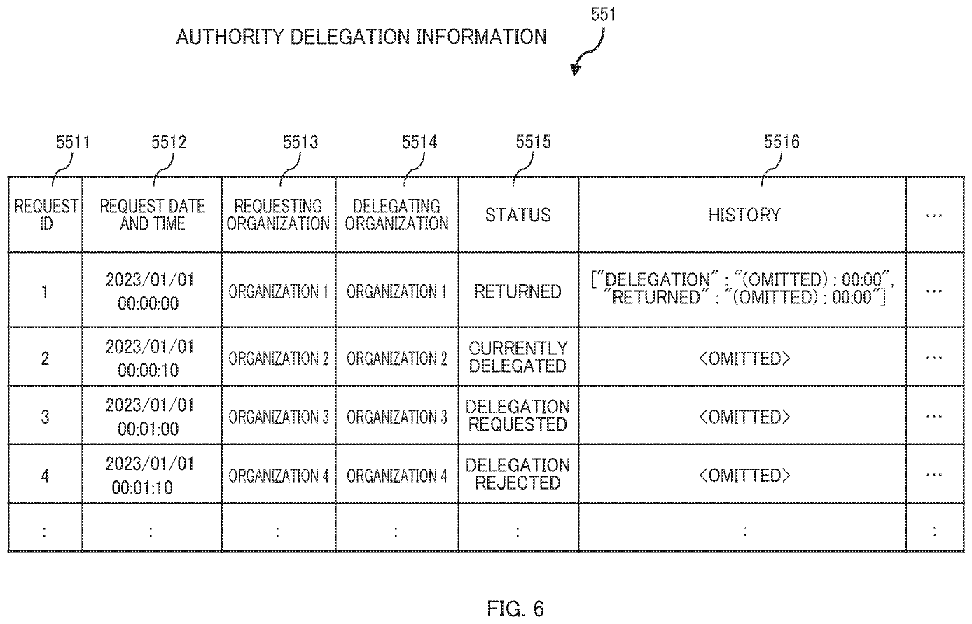

FIG. 6 is an example of authority delegation information 551. As illustrated in FIG. 6, the illustrated authority delegation information 551 is composed of one or more records having items such as a request ID 5511, a request date and time 5512, a requesting organization 5513, a delegating organization 5514, a status 5515, and a history 5516. One record of the authority delegation information 551 corresponds to one authority delegation request.

Of the above items, an identifier of the authority delegation request (hereinafter referred to as “request ID”) is stored in the request ID 5511.

Information indicating the date and time when the authority delegation request occurred is stored in the request date and time 5512.

An identifier (hereinafter referred to as “organization ID”) of a participating organization (hereinafter referred to as “requesting organization”) that has made the authority delegation request is stored in the requesting organization 5513.

The organization ID of the participating organization (hereinafter referred to as the “delegating organization”) that is the delegating source of the authority delegation request is stored in the delegating organization 5514.

Information indicating the current state (situation) of the authority delegation request is stored in the status 5515. In the present embodiment, one of “delegation requested”, “currently delegated”, “delegation rejected”, and “returned” is stored in the status 5515. Note that, in a case where the delegation of management authority is successful, the contents of the status 5515 change in the order of, for example, “delegation requested”->“currently delegated”->“returned”. In addition, in a case where the delegation of management authority fails, for example, “delegation rejected” is stored in the status 5515.

Information regarding the history of the authority delegation request (hereinafter referred to as “history information”) is stored in the history 5516. In this example, the date and time of delegation, returning, and the like is stored in the history 5516 (stored in JSON format in the example illustrated in FIG. 6). By combining information from other item strings with history information, it is possible to obtain, for example, information about an authority delegation request (such as the history and results of delegation/return of management authority, delegation period, and the like). In addition, by tracing the history 5516, it is possible to understand and manage the delegation status of management authority for the entire distributed ledger network (consortium), and for example, it is possible to detect or identify problematic behavior by malicious parties.

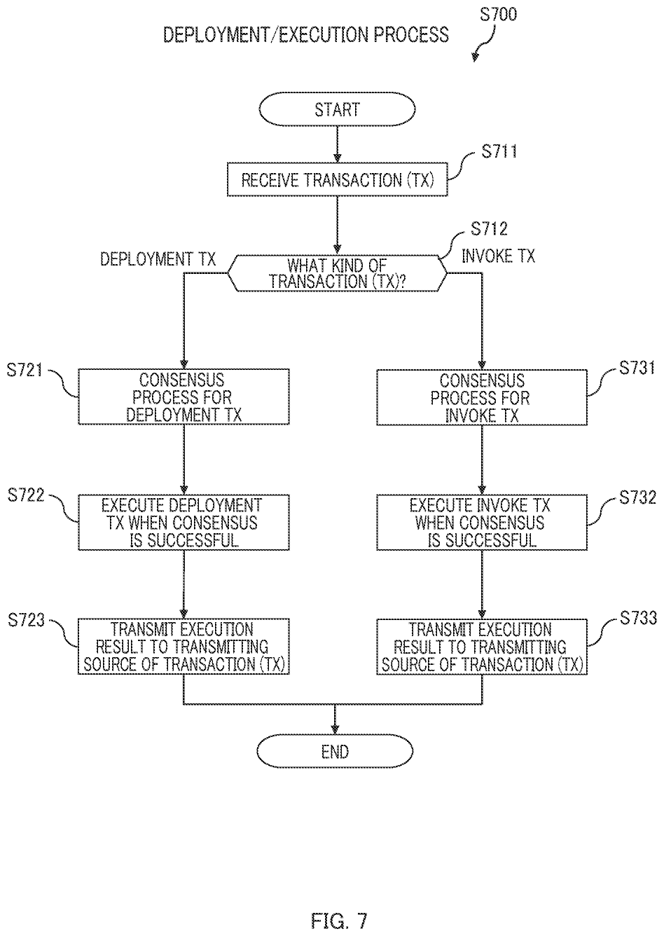

FIG. 7 is a flowchart illustrating a process (hereinafter referred to as “SC deployment/execution process S700”) performed by the distributed ledger node 3 when deploying a smart contract (SC) to the distributed ledger 310 of the distributed ledger node 3 or when executing a smart contract (SC). The SC deployment/execution process S700 is described below with reference to FIG. 7.

First, the TX management unit 320 receives a transaction (TX) for deploying or executing a smart contract (SC) from another node such as the client node 4 (S711).

Next, the consensus management unit 325 of the distributed ledger node 3 determines whether the received transaction (TX) is a deployment TX or an invoke TX (S712). When the received transaction (TX) is a deployment TX (S712: deployment TX), the process advances to S721. When the received transaction (TX) is an invoke TX (S712: invoke TX), the process advances to S731.

In S721, the consensus management unit 325 performs a process for building a consensus with other distributed ledger nodes 3 regarding the execution of the received deployment TX and addition to the BC 311 (hereinafter referred to as a “consensus process”). (S721). Note that the consensus process is performed using, for example, a known technique or a well-known technique. For example, in the “Endorser-Orderer model” disclosed in Non-Patent Document 3, consensus building is performed in the following steps.

First, the consensus management unit 325 selects distributed ledger nodes 3 with approval authority from among the distributed ledger nodes 3 (including itself) participating in the distributed ledger network, and shares the deployment TX with each of the selected distributed ledger nodes 3. Each of the selected distributed ledger nodes 3 verifies (verification of falsification, verification of validity, and the like) whether or not the shared deployment TX has a problem.

The consensus management unit 325 acquires a verification result (“approval” or “disapproval”) from each of the selected distributed ledger nodes 3, and compares the verification result of each distributed ledger node 3 with a preset consensus condition (for example, approval from two or more organizations) to determine whether or not to accept the deployment TX. Then, the consensus management unit 325 transmits the determined result to all of the distributed ledger nodes 3 participating in the distributed ledger network.

Note that in this way, in consensus building based on the “Endorser-Orderer model”, there is no need for all distributed ledger nodes 3 participating in the distributed ledger network to verify transactions (TX), and transactions (TX) may be verified efficiently.

Once a consensus is established, the TX distribution unit 36 (of the distributed ledger node 3) broadcasts the deployment TX to all distributed ledger nodes 3 participating in the distributed ledger network. Then, the SC execution management unit 330 of the distributed ledger node 3 that has received the above deployment TX executes the received deployment TX and deploys a smart contract (SC) related to the deployment TX to the distributed ledger 310 (S722). Note that the deployment is performed by registering the SC_ID and the entity of the smart contract (SC) as state information in the distributed ledger 310 based on the contents of the deployment TX, and adding the block of the relevant deployment TX to the end of the blockchain (BC) (BC 311).

Next, the consensus management unit 325 transmits the execution result of the deployment TX to the sender of the deployment TX (S723).

On the other hand, in S731, the consensus management unit 325 performs a similar consensus process as in S721 regarding the invoke TX. Once a consensus is established, the verified TX distribution unit 335 broadcasts the invoke TX to all distributed ledger nodes 3 participating in the distributed ledger network. The SC execution management unit 330 of the distributed ledger node 3 that has received the invoke TX executes the smart contract (SC) specified by the invoke TX (S732). Note that the smart contract (SC) is executed by specifying a call function specified in the invoke TX and providing input arguments to the smart contract (SC) specified in the invoke TX. By executing the above smart contract (SC), the contents of the distributed ledger 310 are updated, and the block of the invoke TX is added to the end of the blockchain (BC) (BC 311).

Next, the consensus management unit 325 of the distributed ledger node 3 transmits the execution result of the invoke TX to the transmission source of the invoke TX (S733).

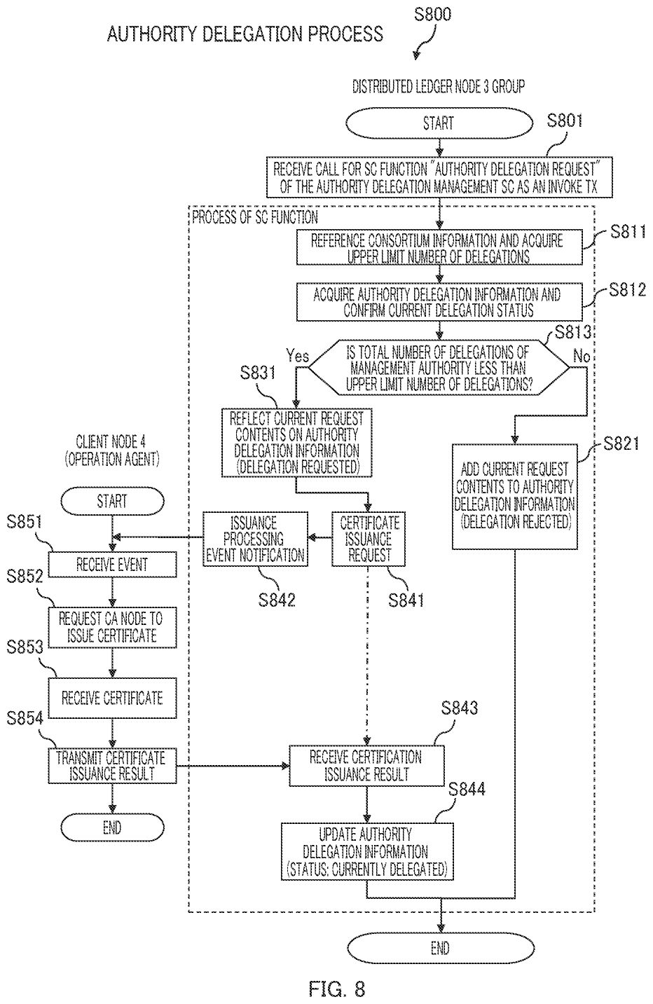

FIG. 8 is a flowchart illustrating a process performed in the distributed ledger system 1 when delegating management authority to an agent (hereinafter referred to as “authority delegation process S800”). The authority delegation process S800 is described below with reference to FIG. 8.

When delegating management authority to an agent, first, the participating organization (requesting organization) that wishes to delegate management authority uses the client node 4 to issue (transmit) the invoke TX of the SC function “authority delegation request 511” of the authority delegation management SC 314 to a distributed ledger node 3 group, and each distributed ledger node 3 (hereinafter, a single distributed ledger node 3 will be explained as the subject) receives the invoke TX (S801). Note that, in this example, it is assumed that the CSR is generated using a management authority key pair for delegation that was generated by the requesting organization itself, and the invoke TX includes the generated CSR.

The SC execution management unit 330 of the distributed ledger node 3 executes the SC function “authority delegation request 511” according to the invoke TX. In the processing of the SC function “authority delegation request 511”, the distributed ledger node 3 first references consortium information 302 and acquires the upper limit number of authority delegations (upper limit number of delegations) for the entire distributed ledger network (consortium) (S811). For example, in the consortium information 302 illustrated in FIG. 4, the number of participating organizations is “10”, the SC Consensus Policy Information is “Approval with node authority or higher from more than half of organizations”, and the Configuration Consensus Policy Information is “Approval with management authority from more than half of organizations”. Therefore, in this case, as long as management authority for six or more organizations is not delegated out, even if the agent obtains multiple management authority, it is possible to prevent falsification of information due to approval of the transaction (TX). Therefore, the upper limit number of delegations in this case is “5 organizations”.

Returning to FIG. 8, the distributed ledger node 3 then refers to the authority delegation information 551 and checks the authority delegation status of the entire distributed ledger network (consortium) (S812). For example, in a case where the authority delegation information 551 has the contents illustrated in FIG. 6, the distributed ledger node 3 lists up delegating organizations whose status 5515 is “currently delegated” from the delegating organizations 5514. In the following, it is assumed that the distributed ledger node 3 lists four organizations: “Organization 2”, “Organization 3”, “Organization 4”, and “Organization 10”.

Returning to FIG. 8, the distributed ledger node 3 next, by delegating new management authority for the invoke TX based on the information acquired in S811 and S812, determines whether the current total number of delegations of management authority in the entire distributed ledger network (consortium) exceeds the upper limit number of delegations (S813). In a case where the total number of delegations exceeds the upper limit number of delegations (S813: No), the process advances to S821. On the other hand, in a case where the total number of delegations does not exceed the upper limit number of delegations (S813: ¥es), the process advances to S831. For example, in a case where the invoke TX delegation request is a request to delegate management authority to “Organization 1”, and if management authority is newly delegated, the total number of delegating organizations will be five, and in this case, since the total number of delegations does not exceed the upper limit number of delegations, the above determination is “¥es” and the process advances to S831. On the other hand, in a case where there is another organization that is requesting to delegate management authority (for example, in a case where “Organization 5” is requesting to delegate management authority), if management authority is newly delegated in response to both requests, the total number of delegating organizations will be six, and in this case, the total number of delegating organizations exceeds the upper limit number of delegations, so the above determination is “No” and the process advances to S821.

In S821, the distributed ledger node 3 adds a record regarding the current authority delegation request to the authority delegation information 551 of the state information 312, and sets “delegation rejected” in the status 5515 of the record. After that, the SC function “authority delegation request 511” ends. In this case, the return value of the SC function “authority delegation request 511” is set to, for example, information indicating that the delegation request has been rejected.

In S831, the distributed ledger node 3 adds a record regarding the current authority delegation request to the authority delegation information 551 of the state information 312, and sets “delegation requested” in the status 5515 of the record.

The processing from S841 is mainly related to issuing a certificate. Note that in the present example, a request to the CA node 6 to issue a certificate is not performed directly to the CA node 6 from the SC function “authority delegation request 511” but by an instruction from the distributed ledger node 3 to the operation agent 445 of the client node 4 of the delegating organization (in this example, the same organization as the requesting organization) via an SC event 222, and then the operation agent 445 receives the above instruction and performs a request to the CA node 6 to issue a certificate.

First, the distributed ledger node 3 generates an issuance processing event 581 in the process of the SC function “authority delegation request 511”, and stores the generated issuance processing event 581 in the SC event 222 (S841 to S842). Note that the issuance processing event 581 includes authority delegation information (organization ID of the delegating organization, request ID of the issuance request, and information about the certificate to be issued (for example, CSR)).

When the operation agent 435 of the client node 4 of the delegating organization receives the issuance processing event 581 (S851), the operation agent 435 of the client node 4 of the delegating organization transmits a certificate issuance request to the CA node 6 in charge of issuing certificates of the delegating organization using the authority delegation information attached to the issuance processing event 581 (S852).

Next, the operation agent 435 receives the certificate from the CA node 6 (S853), and notifies the distributed ledger node 3 of the certificate issuance result (including the request ID and the certificate received from the CA node 6) (S854). Note that the above notification is performed, for example, by executing the SC function of the distributed ledger node 3 (in this example, the SC function is “authority delegation request 511”; however, a different SC function may be used) via the invoke TX.

When the distributed ledger node 3 receives the certificate issuance result (including the issuance request ID and the certificate received from the CA node 6) (S843), the distributed ledger node 3 changes the status 5515 of the record of the authority delegation information 551 corresponding to the received request ID to “currently delegated” and updates the history 5516 (S844). After that, the SC function “authority delegation request 511” ends. Note that in this case, the return value of the SC function “authority delegation request 511” includes, for example, information indicating that the management authority is currently delegated, the contents of the certificate issuance result, and the like.

As an example of the authority delegation process S800, a case has been described above where the SC event 222 of the distributed ledger node 3 and the operation agent 445 of the client node 4 cooperate to perform the process, and this is because in distributed ledger systems, execution of transactions (TX) and direct calls from inside smart contracts (SC) to external systems are often deprecated, prohibited, or unsupported. Note that direct calls are deprecated, prohibited, or unsupported because, for example, in the distributed ledger system described in Non-Patent Document 3, multiple distributed ledger nodes perform transactions (TX) and smart contracts (SC), and thus if a call to an external system is included, the call will be duplicated for multiple nodes. However, when building a consensus, executing a transaction (TX), or executing a smart contract (SC), duplicate calls from multiple distributed ledger nodes 3 to an external system are unnecessary or can be suppressed, or in a case where duplicate calls are allowed or controllable on the external system side, the distributed ledger node 3 may directly request the CA node 6 to issue a certificate. In that case, in the example of FIG. 8, a certificate issuance request is directly transmitted to the CA node 6 in S841, and then the process proceeds directly to S843, and in this case, the processes in S842 and S851 to S854 are unnecessary.

In addition, in S813, the total number of delegations and the upper limit number of delegations are compared to determine whether or not the management authority can be delegated, and, for example, in a case where a consensus condition such as “a specific organization is required, and one or more other optional organizations” is set, the above-mentioned determination is made taking such a consensus condition into account.

Moreover, the determination in S813 may be made using information about the expiration date of the certificate. For example, the management authority may be delegated only when the expiration date of the certificate specified in the CSR included in the authority delegation request is within a certain period of time (for example, 24 hours). As a result, even in a case where there is no request for the return of management authority (authority return request), the management authority will automatically expire after a certain period of time, and it is possible to prevent the risk of management authority remaining in effect for a long period of time.

Furthermore, the expiration date of each certificate is recorded in the authority delegation information 551, and, based on the expiration status of the above expiration date, instead of “Returned” in the status 5515, the current status of the authority delegation request (number of management authorities currently delegated) may be determined. By doing so, the determination in S813 can be appropriately performed even in a case where the process related to returning the authority (authority return process S900 described later) is not performed.

In the above, the number of management authorities currently delegated was counted by adding up the number of delegation requests for which the status 5515 of the authority delegation information 551 was set to “currently delegated”; however, in addition to “currently delegated”, “delegation requested” (a state in which a delegation request has been received from the client node 4 but the actual management authority has not yet been delegated) may also be counted. In addition, in that case, in a case where the management authority of a certain organization is already set to “currently delegated” or “delegation requested” when a delegation request is received from the client node 4 of the organization, the above delegation request may be returned to the client node 4 as “delegation rejected”. Moreover, information (presence or absence of an exclusive lock) indicating that the management authority is “currently delegated” or “delegation requested” may be managed as state information 312 to perform exclusive control over delegation requests. By doing so, it is possible to reliably prevent unexpected simultaneous delegation of management authority and exceeding the total number of delegations.

Further, the upper limit number of delegations may be set using, for example, user-defined information managed by a smart contract (SC). This allows the user to flexibly set the upper limit number of delegations.

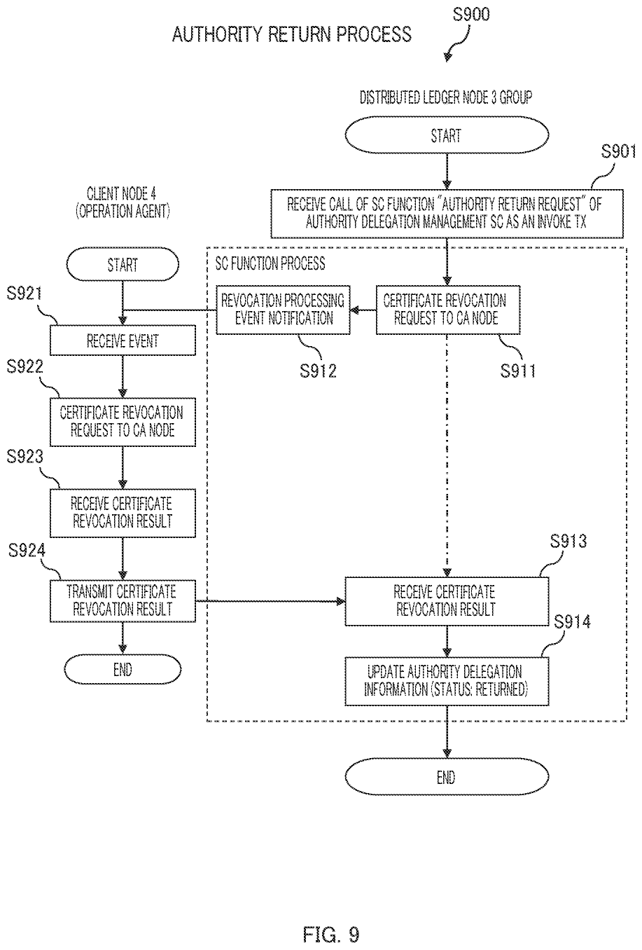

FIG. 9 is a flowchart illustrating a process (hereinafter referred to as “authority return process S900”) performed in the distributed ledger system 1 when the agent returns the management authority to the delegating organization. The authority return process S900 is described below with reference to FIG. 9.

When returning management authority, first, the delegating organization uses the client node 4 to issue an invoke TX (including the specification of the request ID of the issuance request to be revoked) of the SC function “authority return request 512” of the authority delegation management SC 314 to the distributed ledger node 3 group, and each distributed ledger node 3 (hereinafter, a single distributed ledger node 3 will be explained as a subject) receives the invoke TX (S901). Note that in this example, the return of management authority is performed by revoking the management authority delegated to the agent, and in the process related to the revocation a certificate revocation list (hereinafter referred to as “CRL”) is used.

The SC execution management unit 330 of the distributed ledger node 3 executes the SC function “authority return request 512” according to the received invoke TX. In the processing of the SC function “authority return request 512”, the distributed ledger node 3 first generates a revocation processing event 582, and stores the generated revocation processing event 582 in the SC event 222 (S911 to S912). For the reasons described above, in the present example, the certificate revocation request to the CA node 6 is not made directly to the CA node 6 from the SC function “authority revocation request” but is performed by an instruction from the distributed ledger node 3 to the operational agent 445 of the client node 4 via a SC event 222, and upon receiving the above instruction, the operational agent 445 requests the CA node 6 to revoke the certificate. The revocation processing event 582 includes authority delegation information (organization ID of the delegating organization, request ID of the issuance request to be revoked, and information specifying the certificate to be revoked).

When the operation agent 435 of the client node 4 of the delegating organization receives the revocation processing event 852 (S921), the operation agent 435 of the client node 4 of the delegating organization transmits a certificate revocation request to the CA node 6 in charge of issuing certificates of the delegating organization using the authority delegation information attached to the revocation processing event 582 (S922).

Next, the operation agent 435 receives the certificate revocation result (including the request ID and CRL) from the CA node 6 (S923), and notifies the distributed ledger node 3 of the received certificate revocation result (S924). Note that the above-mentioned notification is performed, for example, by executing the SC function of the distributed ledger node 3 (in this example, the SC function is “authority return request 512”, but a different SC function may be used) via the invoke TX.

When the distributed ledger node 3 receives the certificate revocation result (including the request ID and CRL) (S913), the distributed ledger node 3 changes the status of the record of the authority delegation information 551 corresponding to the request ID to “returned” and updates the history 5516 (S914). Note that in this case, the return value of the SC function “authority revocation request” is set to, for example, the content of the certificate revocation result (for example, CRL).

As in the case of the authority delegation process S800 in FIG. 8, when building a consensus, executing a transaction (TX), or executing a smart contract (SC), duplicate calls from multiple distributed ledger nodes 3 to an external system are unnecessary or can be suppressed, or in a case where duplicate calls are allowed or controllable on the external system side, the certificate revocation request to the CA node 6 may be made directly from the distributed ledger node 3. In that case, in the example of FIG. 9, a certificate issuance request is directly sent to the CA node 6 in S911, and then the process proceeds directly to S931, and in this case, the processes in S912 and S921 to S924 are unnecessary.

As described above, with the distributed ledger system 1 of the present embodiment, the delegating of management authority is controlled so that the total number of delegations of management authority does not exceed the upper limit number of delegations for the distributed ledger network (consortium) as a whole. As a result, it is possible to prevent the simultaneous delegation of a number of management authorities that would reduce the tampering resistance of the distributed ledger network (consortium) as a whole. Therefore, for example, it is possible to prevent falsification of the settings of the distributed ledger or distributed ledger network by persons with malicious intent. In this way, with the distributed ledger system 1 of the present embodiment, it is possible to reduce the risk when an organization that operates a distributed ledger network (consortium) has an agent perform the operation on its behalf.

### Second Embodiment

In the first embodiment, a mechanism is described assuming a case in which an agent is able to use a distributed ledger node using the agent's client node. In the second embodiment, an agent transmits an authority delegation request specifying the contents to be performed by the agent to a distributed ledger node (distributed ledger node group). The distributed ledger node checks whether the delegating organization that will delegate management authority has given consent, and when the delegating organization has consented to the delegation of the management authority, the management authority is delegated out. The description below focuses on parts that are different from the first embodiment.

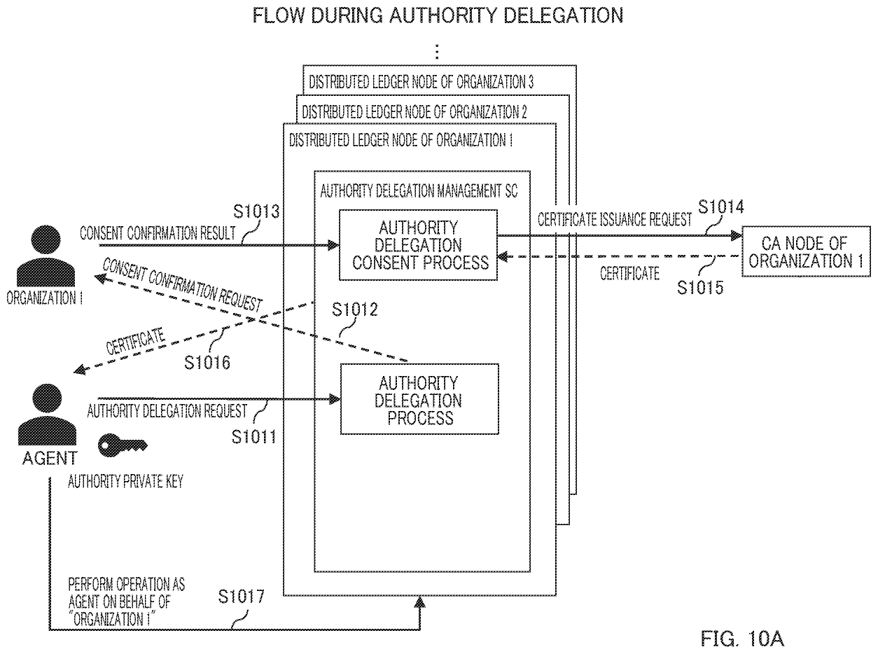

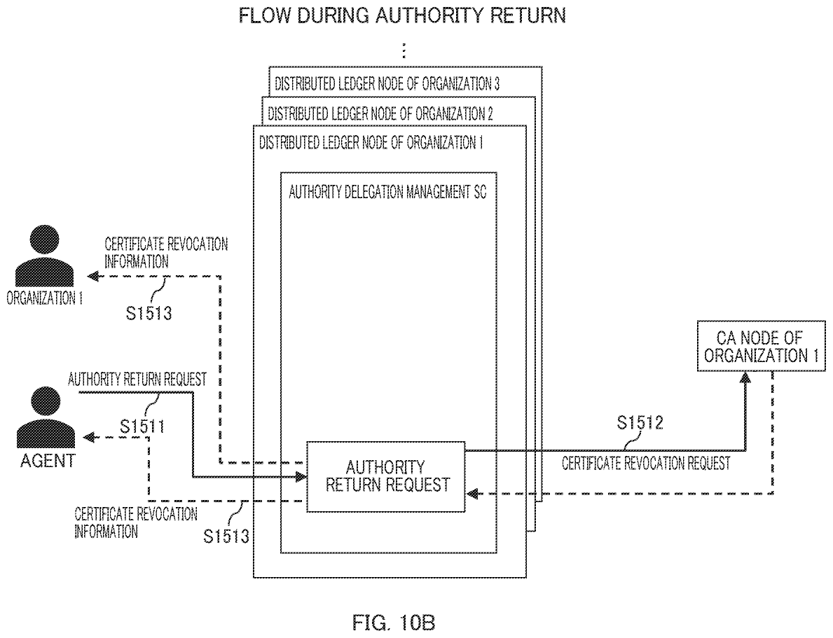

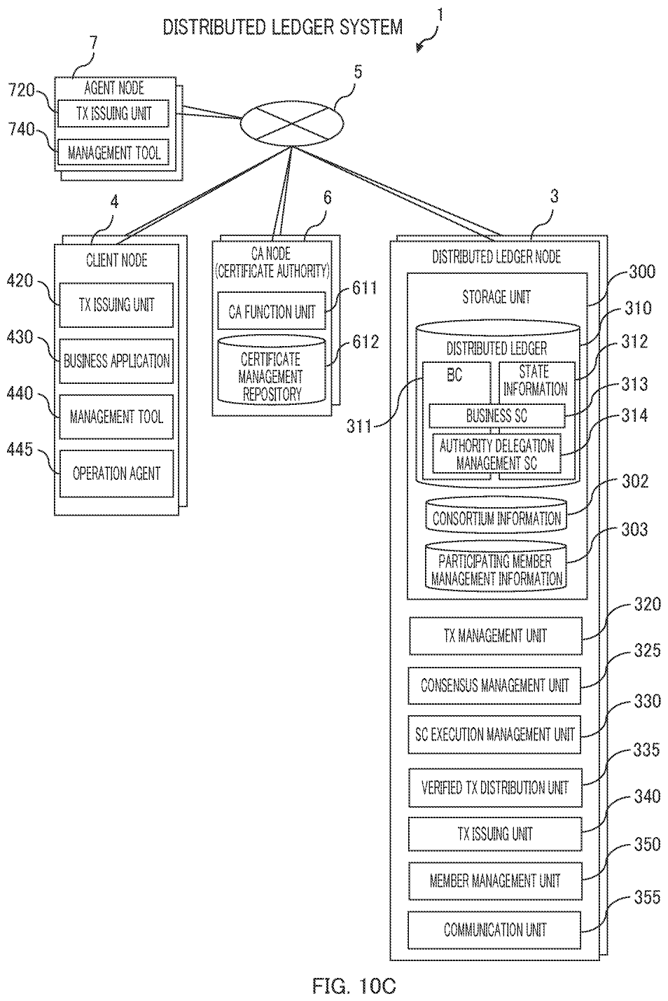

FIG. 10A is a diagram illustrating the flow when a participating organization delegates management authority to an agent.

First, an agent node, which is a node of an agent, transmits an authority delegation request to a distributed ledger node group (S1011). In addition, at this time, the agent generates a key pair for delegation, generates a CSR using the generated key pair, and includes the CSR in the authority delegation request. Note that the generated CSR is used when transmitting a certificate issuance request. Note that the authority delegation request described above includes information about the delegating organization (“Organization 1” in this example) and information indicating the agency contents (an agent menu to be described later).

In the process of the authority delegation management SC, when each distributed ledger node of the distributed ledger node group (hereinafter, a single distributed ledger node will be explained as a subject) receives an authority delegation request, as in the first embodiment, the current total number of delegations of management authority for the entire distributed ledger network (consortium) is acquired, and it is determined whether or not the upper limit number of delegations will be exceeded by newly delegated management authority. In a case where the delegation of management authority is allowed, the distributed ledger node transmits a request to the client node of “Organization 1” to confirm whether or not the delegation of management authority is consented to (hereinafter referred to as the “consent confirmation request”) (S1012).

Upon receiving the consent confirmation request, the client node of “Organization 1” transmits information indicating whether or not the organization consents to the above authority delegation request (hereinafter referred to as “consent confirmation result”) to the distributed ledger node (S1013). In a case where the content of the consent confirmation result is that consent is given, the distributed ledger node sends a certificate issuance request to the CA node (S1014), receives the certificate issued by the CA node, and notifies the agent node (S1015, S1016).

After receiving the certificate information transmitted from the distributed ledger node, the agent node performs the work on behalf of the delegating organization (S1017).

FIG. 10B is a diagram illustrating the flow when the agent returns management authority to the delegating organization (“Organization 1” in FIG. 10B) according to the mechanism of the second embodiment.

As illustrated in FIG. 10B, first, the agent transmits a request to return the management authority delegated to the agent (hereinafter referred to as “authority return request”) to the distributed ledger node group (51511). The authority return request is performed by transmitting a transaction (TX) to each distributed ledger node (hereinafter, a single distributed ledger node 3 is described as the subject) of the distributed ledger node group requesting execution of the authority delegation management SC for the return of management authority.

When the distributed ledger node receives the authority return request, the distributed ledger node transmits a certificate revocation request to the CA node in charge of “Organization 1” (S1512), and transmits information indicating that the certificate has been revoked (hereinafter referred to as “certificate revocation request”) to the client node 4 of “Organization 1” (S154). As a result, the management authority delegated to the agent will be revoked.

Next, the authority delegation management SC transmits certificate revocation information to “Organization 1” and to the agent (S1513).

As described above, in the second embodiment, the agent also participates in the distributed ledger system, and thus a series of processes related to delegating and returning management authority can be completed online.

FIG. 10C schematically illustrates a configuration of a distributed ledger system 1 as a second embodiment. As illustrated in FIG. 10C, the distributed ledger system 1 of the second embodiment includes one or more distributed ledger nodes 3, one or more client nodes 4, one or more CA nodes 6, and one or more agent nodes 7. These are connected to each other via a communication network 5 so as to be able to communicate with each other bidirectionally.

The distributed ledger node 3, client node 4, and CA node 6 are the same as in the first embodiment.

The agent node 7 is a node operated by an agent. The agent node 7 participates in the distributed ledger network and can issue (transmit) a transaction (TX) to the distributed ledger node 3.

The agent node 7 has a TX issuing unit 720 that has the same function as the TX issuing unit 420 of the client node 4, and a management tool 740 that has the same function as the management tool 440 of the client node 4. Note that in the second embodiment, for simplicity of description, it is assumed that the agent does not have a distributed ledger node 3.

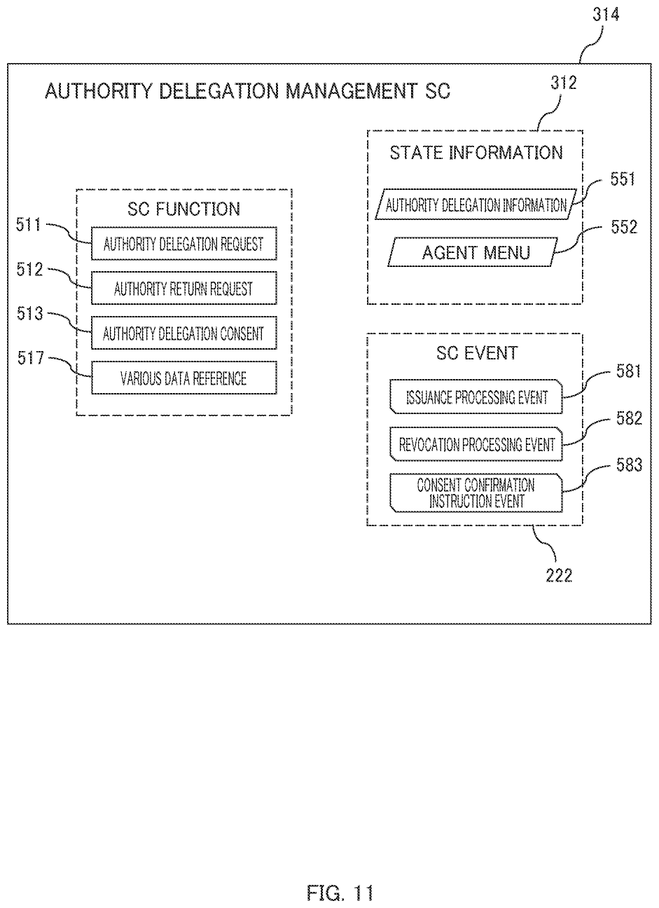

FIG. 11 is a diagram illustrating the authority delegation management SC 314, the state information 312 defined and operated by the authority delegation management SC 314, and the SC event 222 illustrated in FIG. 10C.

As illustrated in FIG. 11, the authority delegation management SC 314 includes SC functions (authority delegation request 511, authority return request 512, authority delegation consent 513, and various data references 517). Note that among the SC functions, the authority delegation request 511, the authority return request 512, and the various data references 517 are the same as in the first embodiment, so explanations of them will be omitted.

The SC function “authority delegation consent 513” is a function that performs processing related to consent by the delegating source in a case where the requesting organization (corresponding to the agent in this example) and the delegating organization are different.

As illustrated in FIG. 11, the state information 312 of the second embodiment includes authority delegation information 551 and an agent menu 552.

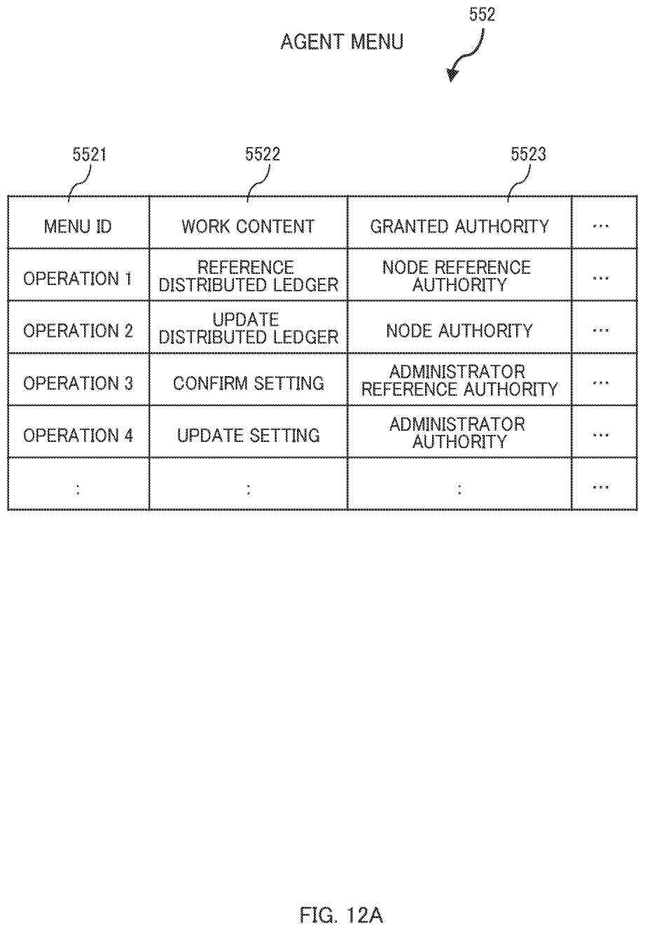

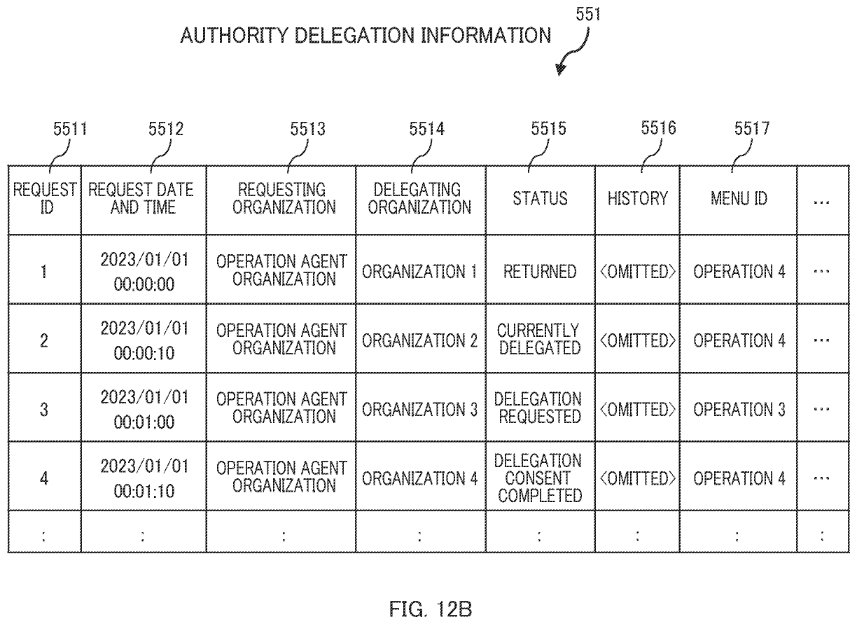

FIG. 12A illustrates an example of the agent menu 552. The illustrated agent menu 552 includes the type (hereinafter referred to as the “agent menu”) and content of work to be performed by the agent, and information indicating the correspondence of management authority to be delegated to an agent when the agent performs the work in the agent menu. Note that, in the present example, it is assumed that the agent specifies the agent menu when transmitting the authority delegation request for management authority to the distributed ledger node 3.

As illustrated in FIG. 12A, the agent menu 552 is composed of one or more records having the following items: menu ID 5521, work content 5522, and granted authority 5523.

Of the above items, an identifier of the agent menu (hereinafter referred to as “menu ID”) is stored in the menu ID 5521.

Information indicating the content of the work in the agent menu performed by the agent is stored in the work content 5522.

Information indicating the type of management authority that is to be delegated to the agent (hereinafter referred to as “granted authority”) when the agent menu is specified is stored in the granted authority 5523.

FIG. 12B illustrates an example of the authority delegation information 551 according to the second embodiment. Of the items of the authority delegation information 551 illustrated, the request ID 5511, the request date and time 5512, the delegating organization 5514, and the history 5516 are items that have the same names as those items in the authority delegation information 551 of the first embodiment illustrated in FIG. 6, and thus a description of those items will be omitted.

An identifier of the agent (hereinafter referred to as “agent ID”) is stored in the requesting organization 5513.

In addition to the status exemplified in the first embodiment, a status of “delegation consent completed” indicating that consent has been given to the delegating organization is also set in the status 5515. Note that in a case where the delegation of the management authority is successful, the content of the status 5515 changes in the order of, for example, “delegation requested”->“delegation consent completed”->“currently delegated”->“returned”. In addition, in a case where delegation of management authority fails, for example, the contents of the status 5515 change in the order of “delegation requested”->“delegation rejected”.

The menu ID of the agent menu requesting an agent in the delegation request is stored in the operation content 5517.

Returning to FIG. 11, the SC event 222 of the second embodiment includes an issuance processing event 581, a revocation processing event 582, and a consent confirmation instruction event 583. Of these, the issuance processing event 581 and the revocation processing event 582 are the same as in the first embodiment.

The consent confirmation instruction event 583 is an SC event in which the distributed ledger node 3 instructs the client node 4 to issue (transmit) an invoke TX that instructs the execution of the SC function “authority delegation consent 513”.

Next, a process performed in the distributed ledger system 1 of the second embodiment when delegating management authority to an agent (hereinafter referred to as “authority delegation process of the second embodiment”) will be described.

Unlike the authority delegation process S800 in the first embodiment shown in FIG. 8, in the authority delegation process of the second embodiment, an authority delegation request (invoke TX of the SC function “authority delegation request 511”) is issued (transmitted) not from the participating organization but from the agent node 7 of the agent to the distributed ledger node 3 group. Note that the above authority delegation request includes the menu ID of the agent menu specified by the agent.

The authority delegation process of the second embodiment has some parts (S801, S811 to S813, S821) in common with the authority delegation process S800 of the first embodiment illustrated in FIG. 8. On the other hand, in the authority delegation process of the second embodiment, in a case where the determination in S813 in FIG. 8 is “¥es”, after confirming the consent (approval) of the delegating organization for delegating the management authority to the agent, a process for delegating the management authority (hereinafter referred to as “authority delegation consent process S1300”) is executed.

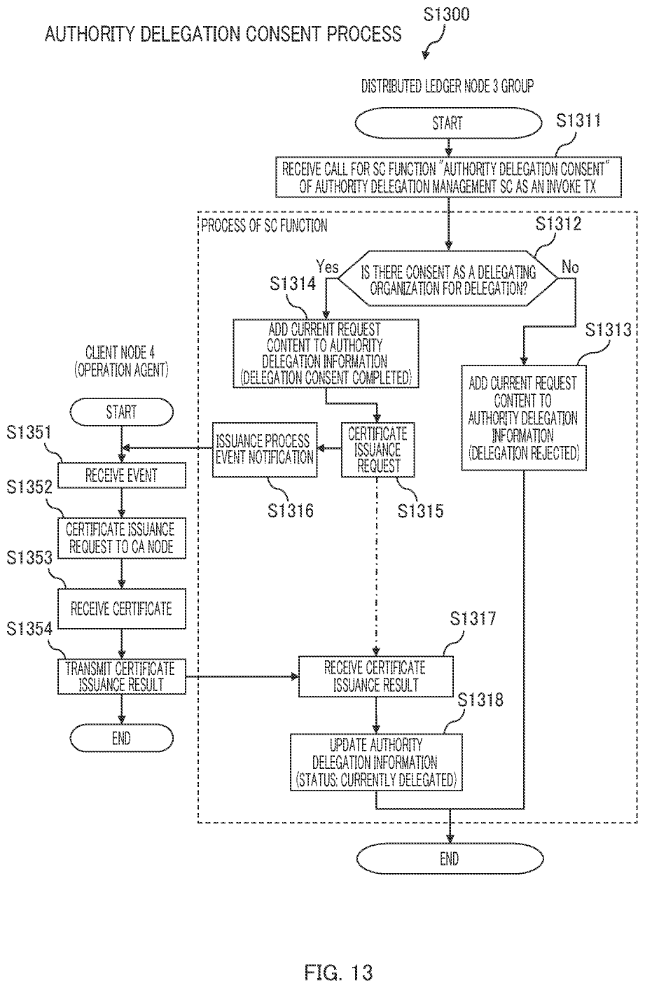

FIG. 13 is a flowchart illustrating the authority delegation consent process S1300. The authority delegation consent process S1300 is described below with reference to FIG. 13.

The authority delegation consent process S1300 is started by the distributed ledger node 3 group storing the consent confirmation instruction event 583 for the delegating organization in the SC event 222 and notifying the delegating organization, the delegating organization that received the notification transmitting an invoke TX of the SC function “authority delegation consent 513” to the distributed ledger node 3 group, and each distributed ledger node 3 (hereinafter, a single distributed ledger node 3 will be explained as the subject) receiving the invoke TX and executing the SC function “authority delegation consent 513”(S1311). Note that the above invoke TX includes information (hereinafter referred to as “consent confirmation result”) indicating whether or not the delegating organization has consented to delegating the management authority to the agent (presence or absence of consent).

In the processing of the SC function “authority delegation consent 513”, the distributed ledger node 3 determines the content of the consent confirmation result attached to the above invoke TX (S1312). In a case where the consent confirmation result indicates that there is no consent (S1312: No), the process advances to S1313. Note that the process in S1313 is similar to that of S821 in FIG. 8, and in this case, the distributed ledger node 3 stores “delegation rejected” in the status 5515 of the authority delegation information 551. In addition, the return value of the SC function “authority delegation consent 513” is set with, for example, information indicating that the delegation request has been rejected.

On the other hand, in a case where the content of the consent confirmation result indicates that there is consent (S1312: ¥es), the process advances to S1314. In S1314, the distributed ledger node 3 stores “delegation consent completed” (or “delegation requested”) in the status 5515 of the authority delegation information 551. After that, by performing the processing corresponding to S841 to S844 in FIG. 8 (accompanying the execution of that processing, the processing of S851 to S854 by the operation agent 435 is also executed), the distributed ledger node 3 acquires a certificate for the management authority to delegate to the agent (type of granted authority associated with the agent menu specified by the agent (granted authority 5523 of the agent menu 552)), and stores the authority “currently delegated” in the status 5515 of the authority delegation information 551. Note that in this case, contents such as information indicating that the management authority is currently delegated, and the contents of the certificate issuance result, are set for the return value of the SC function “authority delegation consent 513”.

Note that, in this embodiment, the granted authority associated with the agent menu is given to the agent; however, for example, the upper limit number of delegations may be set for each granted authority within a range that will not reduce the tampering resistance of the distributed ledger network. In addition, in a case of granting low-risk management authority (for example, “reference authority”) to an agent, the process of obtaining consent from the delegating organization may be omitted. Note that in that case, the same processing as in FIG. 8 of the first embodiment (processing that omits the consent-related processing) is performed.

As described above, with the distributed ledger system 1 of the second embodiment, a series of steps between the delegating organization that is delegating the management authority and the agent may be completed online. Therefore, the series of steps for delegating management authority can be performed safely and efficiently.

### Third Embodiment

By managing the current total number of delegations of management authority so as not to exceed the upper limit number of delegations for the distributed ledger network (consortium) as a whole, the distributed ledger system 1 in the embodiments described above aims to reduce the risk when delegating operation of a distributed ledger node 3 to an agent. Therefore, it is preferable that the current total number of delegations of management authority in the distributed ledger network (consortium) as a whole is always accurately known. However, in reality, unexpected management authority may be issued for some reason.

Therefore, in the third embodiment, the distributed ledger system 1 is provided with a mechanism for detecting the existence of unexpected management authority and correcting (reducing risk) so that the issuing state of the management authority becomes appropriate. Note that the basic configuration of the distributed ledger system 1 of the third embodiment is similar to the configuration of the distributed ledger system 1 of the first embodiment or the second embodiment. In the following, a case where the distributed ledger system 1 of the first embodiment is used as a basis is described as an example. The description below focuses on parts that are different from the first embodiment.

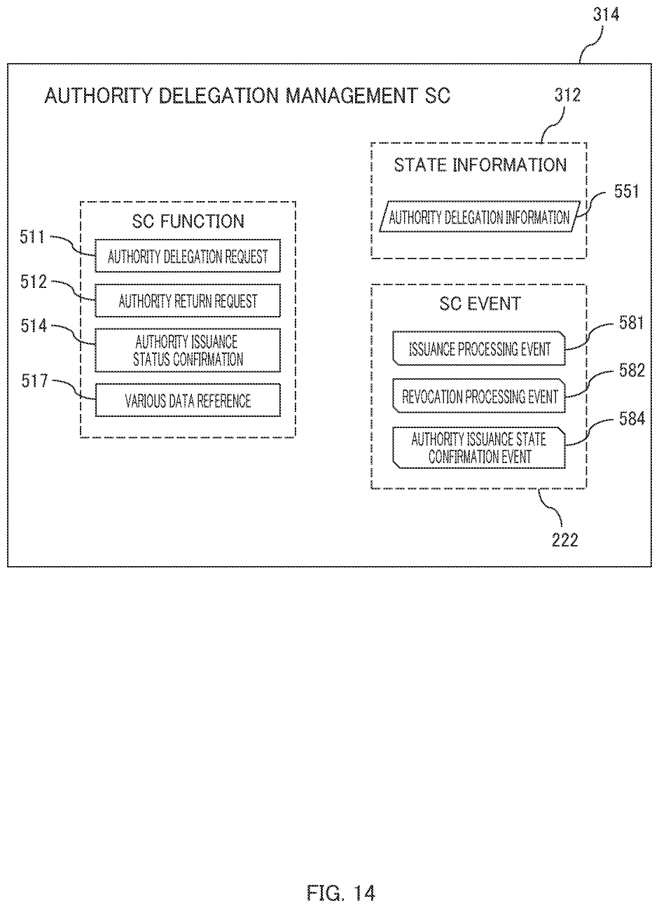

FIG. 14 is a diagram illustrating the authority delegation management SC 314, the state information 312 defined and operated by the authority delegation management SC 314, and the SC event 222 of the third embodiment.

The authority delegation management SC 314 includes SC functions (authority delegation request 511, authority return request 512, authority issuance status confirmation 514, and various data reference 517). Note that among the SC functions, the authority delegation request 511, the authority return request 512, and the various data reference 517 are the same as in the first embodiment, so explanations of them will be omitted.

The authority issuance status confirmation 514 is a function that performs processing related to confirmation of the issuance status of management authority for each organization.

The authority delegation information 551 of the state information 312 is the same as that in the first embodiment, so a description thereof will be omitted.

The SC event 222 of the third embodiment includes an issuance processing event 581, a revocation processing event 582, and an authority issuance status confirmation event 584. Of these, the issuance processing event 581 and the revocation processing event 582 are the same as those in the first embodiment, so a description thereof will be omitted.

The authority issuance status confirmation event 584 is an SC event for instructing the distributed ledger node 3 to issue (transmit) an invoke TX that instructs the client node 4 to execute the SC function “authority issuance status confirmation 514.”

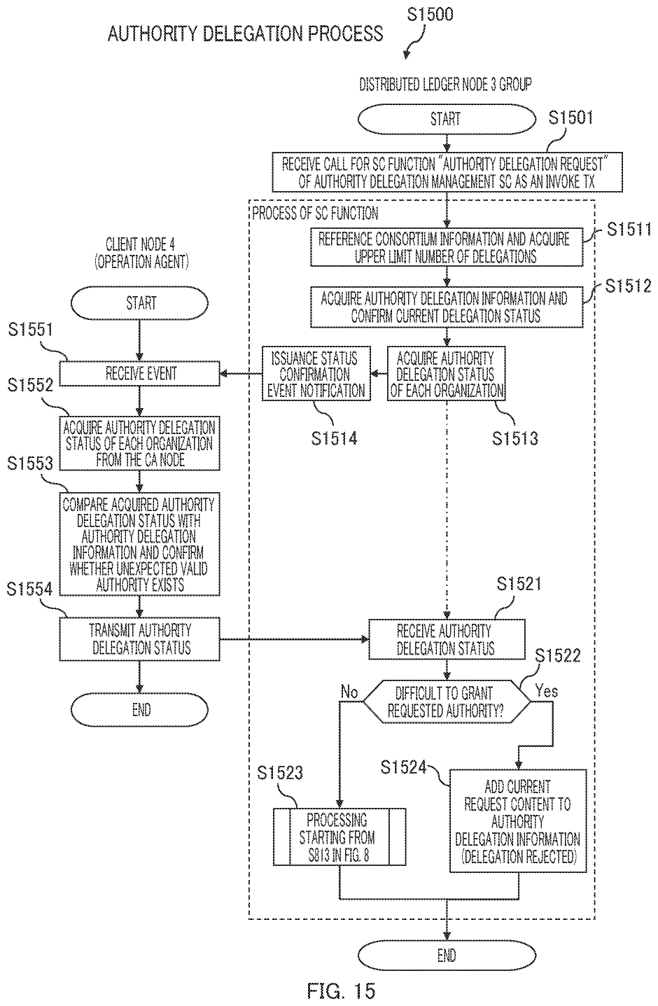

FIG. 15 is a flowchart illustrating a process (hereinafter referred to as “authority delegation process S1500”) performed in the distributed ledger system 1 of the third embodiment when delegating management authority to an agent. The authority delegation process S1500 is described below with reference to FIG. 15.

The processing in S1501 to S1512 illustrated in FIG. 15 is the same as that in S801 to S812 in FIG. 8, so a description thereof will be omitted.

In S1513 to S1514, each distributed ledger node 3 stores the authority issuance status confirmation event 584 in the SC event 222, and instructs the client node 4 of the organization that sent the invoke TX received in S1501 to execute a process to confirm the issuing status of management authority of the participating organization in the distributed ledger network.

After receiving the authority issuance status confirmation event 584 (S1551), the operation agent 435 of the client node 4 of the delegating organization accesses (references) the certificate management repository 612 for the CA node 6 that issues the certificate of the delegating organization and acquires information indicating the issuing status of management authority in the entire distributed ledger network (consortium) (S1552).

Next, the operation agent 435 compares the acquired information with the authority delegation information 551 of the state information 312, and confirms whether or not unexpected currently valid management authority exists (S1553). Note that the operation agent 435 acquires the authority delegation information 551 of the state information 312, for example, by issuing an invoke TX that instructs the distributed ledger node 3 to execute the SC function “various data reference 517”.

Next, the operation agent 435 notifies the distributed ledger node 3 of the confirmation result of S1553 (information indicating whether or not an unexpected currently valid management authority exists) as the issuance status confirmation result (S1554). Note that the operation agent 435 performs the above notification, for example, by issuing an invoke TX that instructs the execution of the SC function that notifies the distributed ledger node 3 of the issuance status confirmation result.

After receiving the above issuance status confirmation result (S1521), the distributed ledger node 3 confirms the contents of the issuance status confirmation result and determines whether it would be difficult to delegate new management authority to the agent (whether there is any problem or not) (S1522). For example, in a case where there is currently valid management authority that is not expected, each distributed ledger node 3 determines that it is necessary to investigate the management authority and determines that delegation would be difficult. In a case where it is determined that delegation would be difficult (S1522: ¥es), the distributed ledger node 3 adds a record regarding the current delegation request to the authority delegation information 551 of the state information 312, and sets “delegation rejected” in the status 5515 of the record. In this case, the return value of the SC function “authority delegation request 511” is set to, for example, information indicating that the delegation request has been rejected. On the other hand, in a case where it is determined that it would not be difficult to issue management authority to the agent (S1522: No), the distributed ledger node 3 executes the processes from S813 onward in FIG. 8 (S1523).

Note that, in a case where the contents of the issuance status confirmation result indicate that an unexpected currently valid management authority exists, the client node 4 or the distributed ledger node 3 may transmit a revocation request to revoke the management authority to the CA node 6.

In addition, in a case where the contents of the issuance status confirmation result indicate that there is an unexpected currently valid management authority, the client node 4 or the distributed ledger node 3 may output warning information (an alert) indicating that an unexpected currently valid management authority exists. Moreover, in the example described above, instruction based on the authority issuance status confirmation event is executed as a trigger; however, processing from S1552 may be executed by defining a periodic execution frequency in the authority delegation management SC 314, and then based on that frequency, having the operation agent of the client node 4 periodically call the data reference function of the authority delegation management SC 314 to acquire the authority delegation status.

In addition, in the above, the issuing status of management authority is confirmed using the operation agent 435 of the client node 4; however, the function may be implemented in the distributed ledger node 3 (for example, implemented in the SC function “authority delegation request 511”).

With the distributed ledger system 1 of the third embodiment, it is possible to detect the existence of unexpected management authority and correct a risky state. Therefore, the risk of tampering with the distributed ledger network (consortium) can be reduced, and the reliability and safety of the entire distributed ledger network (consortium) can be improved.

### Fourth Embodiment

In the above embodiment, a mechanism for managing management authority delegated to an agent has been described; however, during the period when management authority is delegated to an agent, the management authority of the delegating organization may be revoked so that each participating organization has only one management authority for the entire distributed ledger network (consortium).

More specifically, for example, in the process of issuing a certificate of management authority to be delegated to an agent in the authority delegation process S800 of the first embodiment (S841, S851 to S854 in FIG. 8), when issuing a certificate of management authority delegated to an agent, the certificate of management authority used by the delegating organization will be automatically revoked (the management authority will be revoked by transmitting a revocation request to the CA node 6). In addition, when executing the authority return process S900 illustrated in FIG. 9, the delegating organization issues a new identity for the management authority to resume use, and revokes the certificate for the management authority that was delegated to the agent. The new identity is then assigned to the delegating organization by either contacting the delegating organization with the identity for the new management authority or automatically updating the identity managed by the operation agent 445 of the client node 4.

With the mechanism above, the number of management authorities can be controlled so that each participating organization has only one management authority for the entire distributed ledger network (consortium). Therefore, the risk of tampering with the distributed ledger network can be reduced, and the reliability and safety of the entire distributed ledger network (consortium) can be improved.

### Fifth Embodiment

In the above embodiment, the management authority certificate was revoked when the delegated management authority was returned; however, all other identities held by the delegating organization at this timing may also be renewed.

For example, using the first embodiment as an example, in the process of the operation agent 435 of the client node 4 of the delegating organization in the authority return process S900 shown in FIG. 9, the operation agent 435 requests the CA node 6 to renew all other identities held by the delegating organization (revoke the current identity and issue new identities). By automatically updating the identity managed by the operation agent 445 of the client node 4, or by notifying the delegating organization of the new identity, a new identity is given to the delegating organization.

With the mechanism described above, even in a case where a malicious identity is copied or issued while management authority is being delegated, all identities of the delegating organization will be renewed at the time the management authority is returned. Therefore, it is possible to reduce the risk of tampering and increase the reliability and safety of the distributed ledger network (consortium).

### Sixth Embodiment

The authority delegation information 551 (see FIG. 6 and FIG. 12B) described above can be used to control (restrict) the execution of smart contracts (SCs) (for example, a business SC, also referred to as a “second smart contract”) other than the authority delegation management SC 314 (also referred to as a “first smart contract”). For example, the authority delegation information 551 may be used to reduce the risk of tampering when requesting an agent to perform the work of starting up (initial building of) the distributed ledger system 1 or maintain the entire distributed ledger system 1, as described below.

First, prior to the above startup work and maintenance work, the agent is given the management authority for all participating organizations of the distributed ledger network (consortium), and the management authority status 5515 of all participating organizations in the authority delegation information 551 is set to “currently delegated”.

The agent performs the above-mentioned startup work and maintenance work using the given management authority, and after completing the work, hands over the respective distributed ledger nodes 3 and environments to each participating organization. Note that at this stage not all of the management authority has been returned (all management authority belongs to the agent), and thus the participating organizations cannot use the distributed ledger network.

When each participating organization starts using the handed over distributed ledger node 3 and environment, the participating organization performs a process (for example, the authority return process S900 in FIG. 9) of returning the management authority currently delegated to the authority delegation management SC 314, and revokes the management authority that was delegated to the agent for performing the startup work.

Then, by sequentially revoking the management authority of each participating organization that had been delegated to the agent, the total number of delegations in the entire distributed ledger network (consortium) will be below the upper limit number of delegations. As a result, each participating organization can then use the newly built distributed ledger node 3 and environment, and each participating organization can start operating the distributed ledger network. Note, for example, that at the beginning of each SC function of the business SC (second smart contract), logic is provided to determine whether the total number of delegations is less than the upper limit number of delegations, and as long as the total number of delegations does not become less than the upper limit number of delegations, unauthorized use of the business SC can be prevented by rejecting the process of the business SC.

With the mechanism described above, it is possible to reduce the risk of falsification in a case of requesting an agent to perform the startup work (initial building) and maintenance work of the distributed ledger system 1, and each participating organization can safely start operations related to the distributed ledger network.

### Example of an Information Processing Device

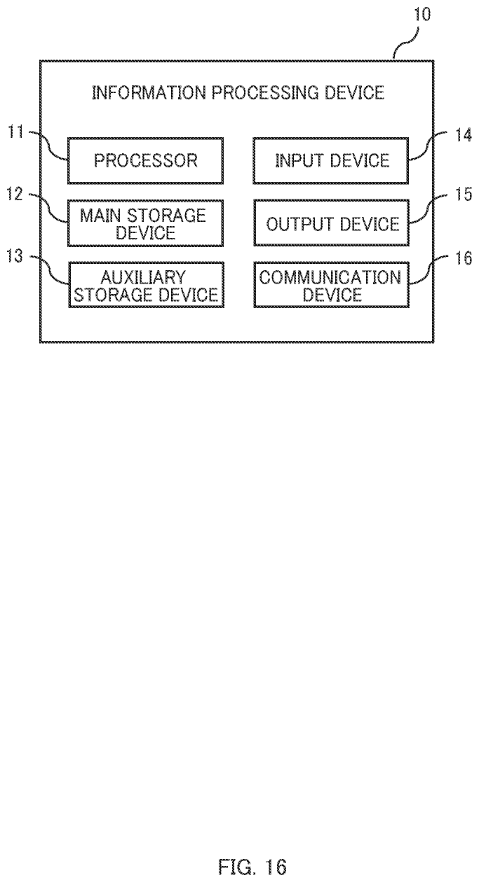

FIG. 16 illustrates an example of an information processing device (computer) used to implement the distributed ledger system 1 described in the above embodiments. The client node 4, the distributed ledger node 3, the CA node 6, and the agent node 7 for the agent are configured using, for example, the illustrated information processing device 10.

The information processing device 10 includes a processor 11, a main storage device 12 (memory), an auxiliary storage device 13 (external storage device), an input device 14, an output device 15, and a communication device 16. These are communicably connected via a bus, communication cable, or the like. Examples of the information processing device 10 include personal computers, various types of server devices, office computers, general-purpose machines (mainframes), smartphones, tablets, and the like.

The information processing device 10 may be implemented in part or in whole by using, for example, virtual information processing resources provided using virtualization technology, process space separation technology, and the like, such as virtual servers provided by cloud systems. In addition, all or part of the functions provided by the information processing device 10 may be implemented by, for example, a service provided by a cloud system via an Application Programming Interface (API) or the like. Moreover, all or part of the functions provided by the information processing device 10 may be implemented using, for example, Software as a Service (SaaS), Platform as a Service (PaaS), Infrastructure as a Service (IaaS), or the like.

The processor 11 is, for example, configured by a Central Processing Unit (CPU), a Micro Processing Unit (MPU), a Graphics Processing Unit (GPU), a Field Programmable Gate Array (FPGA), an Application Specific Integrated Circuit (ASIC), an Artificial Intelligence (AI) chip, or the like.

The main storage device 12 is a device used when the processor 11 executes a program, and includes, for example, Read Only Memory (ROM), Random Access Memory (RAM), non-volatile memory (Non Volatile RAM (NVRAM)), or the like. Various functions implemented by each component of the distributed ledger system 1 are implemented by each processor 11 reading programs and data stored in the auxiliary storage device 13 into the main storage device 12 and executing the programs.

The auxiliary storage device 13 is a device that stores programs and data, and may be configured, for example, by a Solid State Drive (SSD), a hard disk drive, an optical storage device (Compact Disc (CD), Digital Versatile Disc (DVD), or the like), various types of storage systems such as Network Attached Storage (NAS), and the like, reading/writing devices for non-temporary recording media such as IC cards, SD cards, optical recording media, and the like, non-temporary storage areas of cloud servers, and the like. Programs and data can be read into the auxiliary storage device 13 from a non-temporary recording medium or another information processing device equipped with a non-temporary storage device via a recording medium reading device or a communication device 16. Programs and data stored in the auxiliary storage device 13 are read into the main storage device 12 at any time.

The input device 14 is an interface that receives input of information from the outside, and is, for example, a keyboard, a mouse, a touch panel, a card reader, a pen input type tablet, an audio input device, or the like.

The output device 15 is an interface that outputs various information such as processing progress and processing results to the outside. The output device 15 is, for example, a display device that visualizes the above various information (liquid crystal monitor, Liquid Crystal Display (LCD), graphic card, or the like), a device that converts the above various information into audio (audio output device (speaker, or the like)), a device that converts the above various information into text (printing device, or the like), and the like. Note that, for example, a configuration may be adopted in which the information processing device 10 inputs and outputs information to and from other devices via the communication device 16.

The input device 14 and the output device 15 constitute a user interface that achieves interaction processing (receiving information, providing information, and the like) with the user.

The communication device 16 is a device that achieves communication with other devices. The communication device 16 is a wired or wireless communication interface that achieves communication with other devices via the communication network 5, and includes, for example, a Network Interface Card (NIC), a wireless communication module, a USB module, and the like.

For example, an operating system, a file system, a DataBase Management System (DBMS) (relational database, NoSQL, or the like), a Key-Value Store (KVS), or the like may be installed in the information processing device 10.

Although embodiments have been described above, the present invention is not limited to the above embodiments and may include various modifications, nor is it necessarily limited to having all the configurations described.

For example, when the operation agent 445 of the client node 4 requests the CA node 6 to issue a certificate, a private key for the participating organization may be generated, and the generated private key may be passed from the operation agent 445 to the participating organization. In addition, in a case where it is possible to secure a storage area that can be referenced only by the participating organization, a smart contract (SC) may be used to transfer the information.

The functions of the CA node 6 may be implemented in the authority delegation management SC 314. As a result, there is no need to secure an external CA node 6, and the number of nodes required to build the distributed ledger system 1 can be reduced. In addition, a series of processes may be integrated into a smart contract (SC), for example.

Moreover, although the case where the management authority is delegated to an agent has been described above as an example, the destination to which the management authority is delegated is not necessarily limited. For example, the present invention maybe applied to a case where a distributed ledger network is delegated to a person that performs audit work.

### LIST OF REFERENCE NUMBERS

1 Distributed ledger system, 3 Distributed ledger node, 300 Storage unit, 302 Consortium information, 303 Participating member management information, 310 Distributed ledger, 311 Blockchain (BC), 312 State information, 313 Business SC, 314 Authority delegation management SC, 320 TX management unit, 325 Consensus management unit, 330 SC execution management unit, 335 Verified TX distribution unit, 340 TX issuing unit, 345 Node search unit, 350 Member management unit, 355 Communication unit, 4 Client node, 400 Storage unit, 401 Node search information, 420 TX issuing unit, 430 business application, 440 Management tool, 445 Operation agent, 5 Communication network, 6 CA node, 611 CA function unit, 612 Certificate management repository, 7 Agent node, 511 Authority delegation request, 512 Authority return request, 513 Authority delegation consent, 517 Various data references, 551 Authority delegation information, 581 Issuance processing event, 582 Revocation processing event, 583 Consent confirmation instruction event, 584 Authority issuance status confirmation event, S700 SC deployment/execution process, S800 Authority delegation process, S900 Authority return process, S1300 Authority delegation consent process, S1400 Authority delegation process

1. A distributed ledger system comprising 1a plurality of distributed ledger nodes provided by each of a plurality of organizations,
wherein the distributed ledger system provides a distributed ledger network configured by the plurality of distributed ledger nodes,
the distributed ledger system executes a smart contract according to a transaction received from outside,
the smart contract records information in a distributed ledger while building a consensus among the plurality of distributed ledger nodes,
each of the plurality of organizations utilizes the distributed ledger network using management authority granted to each organization,
the distributed ledger system stores an upper limit number of delegations that is an upper limit number of management authorities to be delegated to an agent that performs operations related to the distributed ledger network in an entire distributed ledger network,
the distributed ledger system manages authority delegation information in the distributed ledger, the authority delegation information including information indicating a total number of delegations that is a current number of delegations of the management authority to the agent in the entire distributed ledger network,
the distributed ledger node executes a first smart contract when the distributed ledger node receives the transaction requesting delegation of new management authority, and
the first smart contract:
determines whether or not the total number of delegations exceeds the upper limit number of delegations by delegating the new management authority;
in a case where the total number of delegations exceeds the upper limit number of delegations, determines to reject the request; and
in a case where the total number of delegations is less than the upper limit number of delegations, performs a process of delegating the new management authority and updates the authority delegation information in the distributed ledger.

2. The distributed ledger system according to claim 1, comprising:
a client node that is a node of the organization that is capable of communicating with the distributed ledger node; and
a certificate authority node that is communicably connected to the client node and functions as a certificate authority,
wherein the first smart contract, in the process of delegating the new management authority, generates an event instructing the client node to acquire an electronic certificate for the new management authority, and
the client node:
acquires the instruction by monitoring the event;
acquires the electronic certificate from the certificate authority node by transmitting an instruction to issue the electronic certificate to the certificate authority node according to the acquired instruction; and
transmits, to the distributed ledger node, the transaction notifying that the electronic certificate has been issued, and
the distributed ledger node, upon receiving the transaction, executes the first smart contract to acquire the notification, and updates the authority delegation information managed in the distributed ledger.

3. The distributed ledger system according to claim 1, comprising a certificate authority node that is communicably connected to the distributed ledger node and functions as a certificate authority, or the first smart contract functions as a certificate authority, and
the first smart contract, in the process of delegating the new management authority, acquires an electronic certificate for the new management authority from the certificate authority node or from the function of the first smart contract as the certificate authority, and updates the authority delegation information managed in the distributed ledger.

4. The distributed ledger system according to claim 1, comprising a client node that is a node of the organization that is capable of communicating with the distributed ledger node,
wherein the transaction requesting the delegation of the new management authority is transmitted from the client node to the distributed ledger node.

5. The distributed ledger system according to claim 2, comprising an agent node that is a node of the agent capable of communicating with the distributed ledger node,
wherein the agent node transmits, to the distributed ledger node, the transaction requesting delegation of the management authority necessary for performing the operation as an agent,
the distributed ledger node, upon receiving the transaction, executes the first smart contract, and
the first smart contract:
acquires information indicating whether the organization consents to the delegation of the management authority from the client node; and
in a case where the information is such that the organization does not consent to the delegation of the management authority, the process of delegating the new management authority is not performed even when the total number of delegations is less than the upper limit number of delegations.

6. The distributed ledger system according to claim 5, wherein the transaction requesting the delegation of the management authority transmitted by the agent node to the distributed ledger node includes information indicating a type of the management authority to be delegated to the agent, and
the first smart contract, when delegating the new management authority to the agent, performs a process of delegating the management authority corresponding to the type to the agent.

7. The distributed ledger system according to claim 1, wherein the upper limit number of delegations is set based on a consensus condition for accepting transactions related to execution of the first smart contract managed in the distributed ledger network.

8. The distributed ledger system according to claim 1, comprising:
a client node that is a node of the organization that is capable of communicating with the distributed ledger node; and
a certificate authority node that is communicably connected to the client node and functions as a certificate authority,
wherein the first smart contract generates an event that instructs the client node to acquire a delegation status of the management authority of each of the plurality of organizations that utilize the distributed ledger network, or retains periodic confirmation frequency information, and
the client node, either by acquiring the instruction by monitoring the event and following the acquired instruction, or by periodically referring to the authority delegation information managed by the first smart contract at a frequency described in the confirmation frequency information:
acquires an actual delegation status of the management authority of each of the plurality of organizations from the certificate authority node; and
transmits the transaction notifying of the acquired delegation status of the management authority to the distributed ledger node,
the distributed ledger node, upon receiving the transaction, executes the first smart contract, and
the first smart contract:
determines whether the new management authority is allowed to be delegated based on the actual delegation status of the management authority; and
in a case where the new management authority is determined not to be delegated, does not perform the process of delegating the new management authority.

9. The distributed ledger system according to claim 2, wherein the client node, upon acquiring the instruction by monitoring the event, transmits to the certification authority node a revocation request for the management authority granted to the organization of the client node that has transmitted the transaction requesting delegation of the new management authority.

10. The distributed ledger system according to claim 2, wherein the distributed ledger node, upon receiving the transaction requesting return of the management authority currently delegated by the organization to the agent, executes the first smart contract,
the first smart contract generates an event instructing to revoke the new management authority, and
the client node:
acquires the instruction by monitoring the event;
transmits a revocation request for the management authority to the certificate authority node according to the acquired instruction; and
transmits, to the distributed ledger node, the transaction notifying that the management authority has been revoked, and
the distributed ledger node, upon receiving the transaction, executes the first smart contract to acquire the notification, and updates the authority delegation information managed in the distributed ledger.

11. The distributed ledger system according to claim 1, comprising a second smart contract,
wherein, in a case where the transaction is received for the second smart contract, the second smart contract determines whether the total number of delegations is less than the upper limit number of delegations, and unless the total number of delegations is less than the upper limit number of delegations, the second smart contract rejects the received transaction.

12. A control method for a distributed ledger system, wherein
the distributed ledger system includes 2a plurality of distributed ledger nodes provided by each of a plurality of organizations,
the distributed ledger system provides a distributed ledger network configured by the plurality of distributed ledger nodes, and
each of the plurality of organizations utilizes the distributed ledger network using management authority granted to each organization,
the control method comprising:
a step of executing a smart contract in response to a transaction received from outside by the distributed ledger system;
a step of recording information in a distributed ledger while building a consensus among the plurality of distributed ledger nodes by the smart contract;
a step of storing an upper limit number of delegations that is an upper limit number of management authorities to be delegated to an agent that performs operations related to the distributed ledger network in an entire distributed ledger network, and managing in the distributed ledger authority delegation information including information indicating a total number of delegations that is a current number of delegations of the management authority to the agent in the entire distributed ledger network, by the distributed ledger system;
a step of, upon receiving the transaction requesting delegation of new management authority, executing a first smart contract by the distributed ledger node; and
a step of determining whether or not the total number of delegations exceeds the upper limit number of delegations by delegating the new management authority,
in a case where the total number of delegations exceeds the upper limit number of delegations, determining to reject the request, and
in a case where the total number of delegations is less than the upper limit number of delegations, performing a process of delegating the new management authority and updating the authority delegation information in the distributed ledger, by the first smart contract.

13. The control method for a distributed ledger system according to claim 12, wherein the distributed ledger system includes a client node that is a node of the organization that is capable of communicating with the distributed ledger node and a certificate authority node that is communicably connected to the client node and functions as a certificate authority,
the control method further comprising:
a step of generating an event instructing the client node to acquire an electronic certificate for the new management authority by the first smart contract, in the process of delegating the new management authority;
a step of acquiring the instruction by monitoring the event, acquiring the electronic certificate from the certificate authority node according to the acquired instruction, and transmitting, to the distributed ledger node, the transaction notifying that the electronic certificate has been issue, by the client node; and
a step of, upon receiving the transaction, executing the first smart contract to acquire the notification, and updating the authority delegation information managed in the distributed ledger by the distributed ledger node.

14. The control method for a distributed ledger system according to claim 13, wherein the distributed ledger system includes an agent node that is a node of the agent capable of communicating with the distributed ledger node,
the control method further comprising:
a step of transmitting, to the distributed ledger node, the transaction requesting delegation of the management authority necessary for performing the operation as an agent by the agent node;
a step of, upon receiving the transaction, executing the first smart contract by the distributed ledger node; and
a step of acquiring information indicating whether the organization consents to the delegation of the management authority from the client node, and in a case where the information is such that the organization does not consent to the delegation of the management authority, not performing the process of delegating the new management authority even when the total number of delegations is less than the upper limit number of delegations, by the first smart contract.

15. The control method for a distributed ledger system according to claim 12, wherein the upper limit number of delegations is set based on a consensus condition for accepting transactions related to execution of the first smart contract managed in the distributed ledger network.
